(19) United States
(12) Patent Application Publication
(10) Pub. No.: US 2008/0277810 A1
(43) Pub. Date: Nov. 13, 2008

(54) Method and Apparatus for Manufacturing Plastic Optical Fiber

(75) Inventors: Takanori Sato, Shizuoka (JP); Shuji Nakata, Kanagawa (JP); Tadahiro Kegasawa, Shizuoka (JP); Yukio Shirokura, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Minato-ku, Tokyo (JP)

(21) Appl. No.: 11/547,330

(22) PCT Filed: Mar. 29, 2005
(86) PCT No.: PCT/JP2005/006572

§ 371 Date: Oct. 2, 2006

(30) Foreign Application Priority Data
Apr. 2, 2004 (JP) 2004-110242
Apr. 2, 2004 (JP) 2004-110377

(51) Int. Cl. B29D 11/00

(52) U.S. Cl. 264/1.29; 425/66

(57) ABSTRACT

A preform (15) is hung from an arm (72) into a heating furnace (74). The heating furnace (74) has five heater units (90-94). A gas supply device (77) supplies nitrogen gas to the heating furnace (74). The heating furnace (74) is divided into five sections by orifices (95-100), and the temperature of each divided section is controlled by the heater units (90-94) provided in each section. A seal member (106) attached to the top side of the heating furnace (74) shields the heating furnace (74) from external air, so it is possible to prevent turbulence in the divided sections in the heating furnace (74).

### TECHNICAL FIELD

The present invention relates to a method and an apparatus for manufacturing a plastic optical fiber.

### BACKGROUND ART

Recent development in communication industry, the demand for the optical fiber with lower transmission loss and low manufacture cost has been increased. A plastic optical part has merits of design facility and low manufacture cost, compared with a glass optical part with identical structure. Especially, a plastic optical fiber (referred to as “POF”), entirely composed of a plastic material is suitable for manufacture of the optical fiber with large diameter at a low cost, because the POF has advantages in excellent flexibility, light weight and high machinability, compared with the glass optical fiber. Accordingly, it is planned to utilize the plastic optical fiber as an optical transmission medium for short-distance purpose in which the transmission loss is small (for example, Japanese Laid-Open Patent Publication (JP-A) No. 61-130904).

The POF is composed of a core part formed from a plastic, and an outer shell (referred to as “clad” or “clad part”) that is formed from a plastic having smaller refractivity than the core part. The POF is manufactured, for example, by forming a tubular clad part (referred to as “clad pipe”) by melt-extrusion, and by forming the core part in the clad pipe. A graded index (GI) type POF, in which the refractive index in the core part gradually decreases from the center to the surface of the core part, has high transmission band and high transmission capacity. Various methods for manufacture of the GI type POF are disclosed. For instance, U.S. Pat. No. 5,541,247 (counterpart of Japan Patent No. 3332922) describes a method to manufacture the GI type POF by forming an optical fiber base body (hereinafter referred to “preform”) by use of interfacial gel polymerization, and then by melt-drawing the preform in a heating furnace.

In manufacturing a glass optical fiber, a heating furnace is tightly kept in an airtight manner and purged with inert gas, so that external air do not flow into the heating furnace, as described in JP-A No. 2003-171139. Thereby, it is possible to prevent oxidization of the heating furnace and deterioration of the glass optical fiber by oxidization.

The preform for forming the POF, especially for the graded index type and the multi-step type POF, comprises plural resin layers having different melt viscosity, so the melt condition of the preform is disturbed if the temperature in the heating furnace is fluctuated in melt-drawing the preform. As a result, the diameter of the POF to be drawn is also fluctuated, and thereby the optical property such as the optical transmission loss becomes worse. Moreover, in a coating process to form a protective layer around the POF, a nipple or a die in the coating apparatus will catch the POF if the diameter of the POF is fluctuated. Catching the POF by the nipple or the die causes the problem in the manufacture process and the quality of the manufactured POF. Dividing the heating furnace to decrease turbulence of the temperature in the heating furnace is not sufficient in controlling the outer diameter of the POF. The method described in JP-A No. 2003-171139 can shield the heating furnace from external air, but does not deal with the problem of fluctuation in temperature distribution in the heating furnace. The method described in JP-A No. 2003-171139 recites to the glass optical fiber, so a high heating temperature (about 2000° C.) is needed in the melt-drawing process. Because of high temperature in the heating furnace, a small change in the temperature in the heating furnace does not cause fluctuation in the diameter of the optical fiber.

In order to prevent void (bubble) and deformation caused by shrinkage of the cooled resin in melt-drawing the preform to manufacture the POF, it is well known to form the preform having the hollow cylindrical shape. As the material of the preform, an amorphous polymer with fluorine that does not contain C—H bond is suggested. For the purpose of preventing voids in the POF that is manufactured from the hollow cylindrical preform, it is studied to realize optimum design of the decompression degree in the hollow part, the ratio of the outer-diameter and the inner diameter of the hollow preform, the outer diameter, and so forth (see JP-A No 8-334366 and PCT Publication WO/40768, for example).

The method described in JP-A No. 8-334366 recites to a rotationally formed preform of an amorphous polymer with fluorine that does not contain the C—H bond, for the purpose of enabling transmission in a wide wavelength range. The core part of the preform is formed from acrylic resin in terms of the manufacture cost, however, the method as described in JP-A No. 8-334366 cannot be applied to manufacturing the POF of acrylic resin.

In PCT Publication WO/40768, the material for the preform is limited to fluorine contained amorphous polymer without the C—H bond, so it is difficult to utilize the decompression condition in the hollow part of the preform, the regulations of the diameter ratio and the outer diameter, in manufacturing the acrylic POF. Thus, when the acrylic POF is formed from the hollow cylindrical preform in order to reduce the manufacture cost, a void such as a bubble remained in the POF causes deterioration in the optical transmittance.

An object of the present invention is to provide a method and an apparatus for manufacturing a plastic optical fiber that is capable of controlling fluctuation in the outer diameter of the plastic optical fiber.

Another object of the present invention is to provide a method of manufacturing the plastic optical fiber with excellent optical properties from a hollow cylindrical preform by reducing bubbles in the plastic optical fiber.

### DISCLOSURE OF INVENTION

The above object is achieved by sealing the heating furnace in air-tight manner and controlling fluctuation in the temperature in the heating furnace. In a preferred embodiment, the heating furnace has more than two heater units that are independently controlled. An orifice is provided between the heater units to divide the heater units, and a seal member is provided at least one of the bottom side and/or the top side to keep the heating furnace from external air. A substantially circular opening is formed in the seal member attached to the top side of the heating furnace. The diameter D3 (mm) of the opening of the seal member in the top side is large enough to pass the plastic optical fiber base material having the diameter D1 (mm). These diameters D1 and D3 preferably satisfy the following condition:

D1<D3≦1.5×D1

Instead, the diameters D1 and D3 may satisfy the following condition when the outer surface of the plastic optical fiber base material is coated with a part of the seal member:

0.75×D1≦D3≦D1

An opening to pass the plastic optical fiber is formed in the seal member attached to the bottom side of the heating furnace. The diameter D5 (mm) of the plastic optical fiber and the diameter D6 (mm) of the opening in the seal member in the bottom side satisfy the following condition:

1.2×D5≦D6≦10×D5

The temperature fluctuation in the divided area of the heating furnace from a set temperature is preferably ±0.5° C., more preferably ±0.3° C., and most preferably ±0.2° C. It is preferable to provide a gas supply device to supply one of helium gas, argon gas and nitrogen gas to the heating furnace.

The above object is also achieved by melt-drawing a plastic optical fiber base material having a hollow cylindrical core part and a clad part around the core part while the hollow part in the core part is decompressed at a pressure from (−10 kPa to atmospheric pressure) to (−0.4 kPa to atmospheric pressure). The heating furnace for heating and melt-drawing the plastic optical fiber base material is preferably divided into plural sections that are capable of controlling the temperature independently. In each of the sections from the entrance side to the section in which the hollow part of the base material disappears, the variation in the temperature is preferably ±0.5° C. from the set value.

In another preferable embodiment, the variation in the decompressed pressure from the set pressure P is 0.001×P to 0.5×P. The variation in the decompressed pressure is preferably equal to or less than 0.5 kPa. The outer diameter D1 (mm) of the plastic optical fiber base material is preferably 10 mm to 100 mm. The diameter D2 (mm) of the hollow part of the plastic optical fiber base material is preferably 0.05×D1 (mm) to 0.4×D1 (mm), and more preferably 0.05×D1 (mm) to 0.35×D1 (mm), and most preferably 0.05×D1 (mm) to 0.3×D1 (mm). The main component of the core part is preferably a polymer of a bulk polymerizable monomer. The polymer is preferably acrylic resin, and more preferably polymethyl methacrylate.

The core part may have refractive index profile in which the refractive index decreases from the center to the interface with the clad part. Such core part can be formed by pouring a reactive solution including polymerizable monomer and a refractive index control agent in a hollow cylindrical pipe in which at least the clad part is formed, by setting the hollow pipe horizontally, and by polymerizing the reactive solution while the hollow cylindrical pipe is rotated. The polymerizable monomer is preferably methyl methacrylate.

According to the present invention, by controlling variation in the temperature in the heating furnace within ±0.5° C. to the set temperature by use of the orifices and the seal members, it is possible to decrease fluctuation in the outer diameter of the manufactured plastic optical fiber.

In addition, since the pressure in the hollow part in the plastic optical fiber base material is from (−10 kPa to atmospheric pressure) to (−0.4 kPa to atmospheric pressure), the amount of the bubbles in the manufactured plastic optical fiber decreases. Thereby, it is possible to prevent deterioration in the transmission loss of the plastic optical fiber.

### BRIEF DESCRIPTION OF DRAWINGS

FIG. 1 is a flow chart of a manufacture method of a plastic optical fiber;

FIG. 2 is a sectional view, in essential part, of an apparatus to manufacture a clad part of the plastic optical fiber;

FIG. 3 is a schematic view of the manufacture line of the clad part;

FIG. 4 is a sectional view of essential part of the manufacture line of FIG. 3;

FIG. 5A is a sectional view of a preform for the plastic optical fiber;

FIG. 5B is a graph to show the refractive index profile in the radial direction of the preform;

FIG. 6 is a schematic view of a manufacture equipment of the plastic optical fiber;

FIG. 7 is a sectional view, in essential part, of the equipment of FIG. 6;

FIG. 8 is a plan view, in essential part, of a seal member provided with the manufacture equipment of FIG. 6;

FIG. 9 is a schematic view, in essential part, of the variation of the manufacture equipment;

FIG. 10 is a plan view, in essential part, of the seal member provided with the manufacture equipment of FIG. 9;

FIGS. 11 though 13 are schematic views, in essential part, of the variations of the manufacture equipment;

FIG. 14 is a partial perspective view of a reactor to manufacture the preform, according to the second embodiment;

FIG. 15 is a sectional view of the preform for the plastic optical fiber;

FIG. 16 is a schematic view of a manufacture equipment of the plastic optical fiber, according to the second embodiment; and

FIG. 17 is a sectional view, in essential part, of the equipment of FIG. 16.

### BEST MODE FOR CARRYING OUT THE INVENTION

### Embodiment 1

A plastic optical fiber has a core part and a clad part both of which are formed from polymers. In the preferable embodiments, the POF (plastic optical fiber) is comprised of the core part and the clad part.

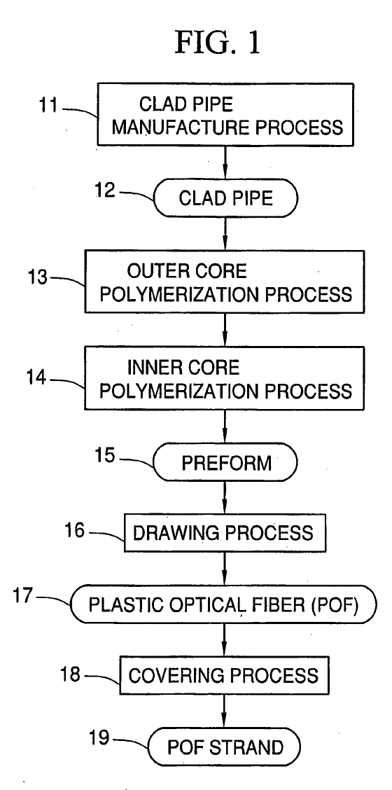

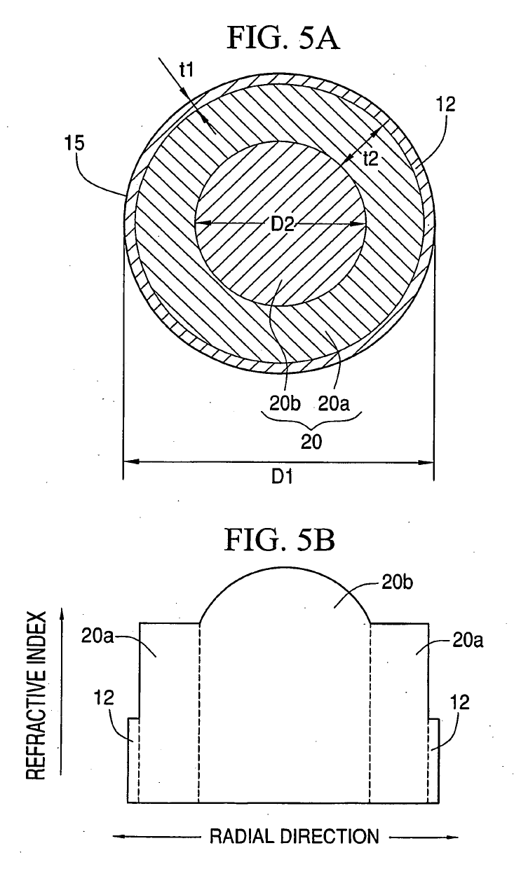

FIG. 1 is the flow chart of the manufacture method of the POF. In a clad pipe manufacturing process 11, a clad pipe 12 is produced by melt-extrusion of the polymers as the raw material. The clad pipe manufacturing process 11 will be described in detail. Then, in an outer core polymerization process 13, an outer core 20a (see FIG. 5A) is formed on the inner surface of the clad pipe 12. After preparing an outer core formation solution (outer core solution) including polymerizable composition, the outer core solution is poured into the clad pipe 12 to carry out polymerization of the outer core. Then, in an inner core polymerization process 14, an inner core 20b (see FIG. 5A) is formed in the outer core 20a. After preparing an inner core formation solution (inner core solution), the inner core solution is poured into the clad pipe 12 having the outer core 20a. The inner core 20b is formed by polymerization of the inner core solution. A preform 15 is obtained by forming the outer core 20a and the inner core 20b that consists of the core part 20.

In a drawing process 16 which will be described in detail, the preform 15 is heated and subject to the melt-drawing process to produce the POF 17. Although the POF 17 itself can be used as an optical transmission medium, the POF 17 is preferably coated with a coating layer for protecting the surface of the POF 17 and for handling with ease. After forming the coating layer around the POF 17 in a coating process 18, a plastic optical fiber strand 19 (referred to as “optical fiber strand”) is obtained. The optical fiber strand 19 is also referred to as a plastic optical fiber cable.

(Core Part)

As the raw material of the core part, it is preferable to select a polymerizable monomer that is easily bulk polymerized. Examples of the raw materials with high optical transmittance and easy bulk polymerization are (meth)acrylic acid esters [(a) (meth)acrylic ester without fluorine, (b) (meta)acrylic ester containing fluorine], (c) styrene type compounds, (d) vinyl esters, or the like. The core part may be formed from homopolymer composed of one of these monomers, from copolymer composed of at least two kinds of these monomers, or from a mixture of the homopolymer(s) and/or the copolymer(s). Among them, (meth)acrylic acid ester can be used as a polymerizable monomer.

Concretely, examples of the (a) (meth)acrylic ester without fluorine as the polymerizable monomer are methyl methacrylate (MMA); ethyl methacrylate; isopropyl methacrylate; tert-butyl methacrylate; benzyl methacrylate (BzMA); phenyl methacrylate; cyclohexyl methacrylate, diphenylmethyl methacrylate; tricyclo[5·2·1·0^{2.6}]decanyl methacrylate; adamanthyl methacrylate; isobonyl methacrylate; methyl acrylate; ethyl acrylate; tert-butyl acrylate; phenyl acrylate, and the like. Examples of (b) (meth)acrylic ester with fluorine are 2,2,2-trifluoroethyl methacrylate; 2,2,3,3-tetrafluoro propyl methacrylate; 2,2,3,3,3-pentafluoro propyl methacrylate; 1-trifluoromethyl-2,2,2-trifluoromethyl methacrylate; 2,2,3,3,4,4,5,5-octafluoropenthyl methacrylate; 2,2,2,3,3,4,4,-hexafluorobutyl methacrylate, and the like. Further, in (c) styrene type compounds, there are styrene; α-methylstyrene; chlorostyrene; bromostyrene and the like. In (d) vinylesters, there are vinylacetate; vinylbenzoate; vinylphenylacetate; vinylchloroacetate; and the like. The polymerizable monomers are not limited to the monomers listed above. Preferably, the kinds and composition of the monomers are selected such that the refractive index of the homopolymer or the copolymer in the core part is similar or higher than the refractive index in the clad part. As the polymer for the raw material, polymethyl methacrylate (PMMA), which is a transparent resin, is more preferable.

When the POF 17 is used for near infrared may, the C—H bond in the optical member causes absorption loss. By use of the polymer in which the hydrogen atom (H) of the C—H bond is substituted by the heavy hydrogen (D) or fluorine (F), the wavelength range to cause transmission loss shifts to a larger wavelength region. Japanese Patent No. 3332922 teaches the examples of such polymers, such as deuteriated polymethylmethacrylate (PMMA-d8), polytrifluoroethylmethacrylate (P3FMA), polyhexafluoroisopropyl-2-fluoroacrylate (HFIP 2-FA), and the like. Thereby, it is possible to reduce the loss of transmission light. It is to be noted that the impurities and foreign materials in the monomers that causes dispersion should be sufficiently removed before polymerization so as to keep the transparency of the POF 17 after polymerization.

(Clad Part)

In order that the transmitted light in the core part is completely reflected at the interface between the core part and the clad part, the material for the clad part is required to have smaller refractive index than the core part and exhibits excellent fitness to the core part. If there is irregularity between the core part and the clad part, or if the material for the clad part does not fit the core part, another layer may be provided between the core part and the clad part. For example, an outer core layer, formed on the surface of the core part (inner wall of the tubular clad pipe) from the same composition as the matrix of the core part, can improve the interface condition between the core part and the clad part. The description of the outer core layer will be explained later. Instead of the outer core layer, the clad part may be formed from the polymer having the same composition as the matrix of the core part.

A material having excellent toughness, moisture resistance and heat-resistance is preferable for the clad part. For example, a polymer or a copolymer of the monomer including fluorine is preferable. As the monomer including fluorine, vinylidene fluoride (PVDF) is preferable. It is also preferable to use a fluorine resin obtained by polymerizing one kind or more of polymerizable monomer having 10 wt % of vinylidene fluoride.

In the event of forming the clad part of the polymer by melt-extrusion, the viscosity of the molten polymer needs to be appropriate. The viscosity of the molten polymer is related to the molecular amount, especially the weight-average molecular weight. In this preferable embodiment, the weight-average molecular weight is preferably 10,000 to 1,000,000, and more preferably 50,000 to 500,000.

It is also preferable to protect the core part from moisture. Thus, a polymer with low water absorption is used as the material for the clad part. The clad part may be formed from the polymer having the saturated water absorption (water absorption) of less than 1.8%. More preferably, the water absorption of the polymer is less than 1.5%, and most preferably less than 1.0%. The outer core layer is preferably formed from the polymer having similar water absorption. The water absorption (%) is obtained by measuring the water absorption after soaking the sample of the polymer in the water of 23° C. for one week, pursuant to the ASTM D 570 experiment.

(Polymerization Initiators)

In polymerizing the monomer to form the polymer as the core part and the clad part, polymerization initiators can be added to initiate polymerization of the monomers. The polymerization initiator to be added is appropriately chosen in accordance with the monomer and the method of polymerization. Examples of the polymerization initiators are peroxide compounds, such as benzoil peroxide (BPO); tert-butylperoxy-2-ethylhexanate (PBO); di-tert-butylperoxide (PBD); tert-butylperoxyisopropylcarbonate (PBI); n-butyl-4,4-bis(tert-butylperoxy)valarate (PHV), and the like. Other examples of the polymerization initiators are azo compounds, such as 2,2′-azobisisobutylonitril; 2,2′-azobis(2-methylbutylonitril); 1,1′-azobis(cyclohexane-1-carbonitryl); 2,2′-azobis(2-methylproparhe); 2,2′-azobis(2-methylbutane)2,2′-azobis(2-methylpentane); 2,2′-azobis(2,3-dimethylbutane); 2,2′-azobis(2-methylhexane); 2,2′-azobis(2,4-dimethylpentane); 2,2′-azo bis (2,3,3-trimethylbutane); 2,2′-azobis(2,4,4-trimethylpentane); 3,3′-azobis(3-methylpentane); 3,3′-azobis(3-methylhexane); 3,3′-azobis(3,4-dimethypentane); 3,3′-azobis(3-ethylpentane); dimethyl-2,2′-azobis (2-methylpropionate); diethyl-2,2′-azobis (2-methylpropionate); di-tert-butyl-2,2′-azobis(2-methylpropionate), and the like. Note that the polymerization initiators are not limited to the above substances. More than one kind of the polymerization initiators may be combined.

(Chain Transfer Agent)

The polymerizable composition for the clad part and the core part preferably contain a chain transfer agent for mainly controlling the molecular weight of the polymer. The chain transfer agent can control the polymerization speed and polymerization degree in forming the polymer from the polymerizable monomer, and thus it is possible to control the molecular weight of the polymer. For instance, in drawing the preform to manufacture the POF, adjusting the molecular weight by the chain transfer agent can control the mechanical properties of the POF in the drawing process. Thus, adding the chain transfer agent makes it possible to increase the productivity of the POF.

The kind and the amount of the chain transfer agent are selected in accordance with the kinds of the polymerizable monomer. The chain transfer coefficient of the chain transfer agent to the respective monomer is described, for example, in “Polymer Handbook, 3^{rd} edition”, (edited by J. BRANDRUP & E. H. IMMERGUT, issued from JOHN WILEY&SON). In addition, the chain transfer coefficient may be calculated through the experiments in the method described in “Experiment Method of Polymers” (edited by Takayuki Ohtsu and Masayoshi Kinoshita, issued from Kagakudojin, 1972).

Preferable examples of the chain transfer agent are alkylmercaptans [for instance, n-butylmercaptan; n-pentylmercaptan; n-octylmercaptan; n-laurylmercaptan; tert-dodecylmercaptan, and the like], and thiophenols [for example, thiophenol; m-bromothiophanol; p-bromothiophenol; m-toluenethiol; p-toluenethiol, and the like]. It is especially preferable to use n-octylmercaptan, n-laurylmercaptan, and tert-dodecylmercaptan in the alkylmercaptans. Further, the hydrogen atom on C—H bond may be substituted by the fluorine atom (F) or a deuterium atom (D) in the chain transfer agent. Note that the chain transfer agents are not limited to the above substances. More than one kind of the chain transfer agents may be combined.

(Refractive Index Control Agent)

The refractive index control agent may be preferably added to the polymerizable composition for the core part. It is also possible to add the refractive index control agent to the polymerizable composition for the clad part. The core part having refractive index profile can be easily formed by providing the concentration distribution of the refractive index control agent. Without the refractive index control agent, it is possible to form the core part having refractive index profile by providing the profile in the co-polymerization ratio of more than one kind of the polymerizable monomers in the core part. But in consideration of controlling the composition of the copolymer, adding the refractive index control agent is preferable.

The refractive index control agent is referred to as “dopant”. The dopant is a compound that has different refractive index from the polymerizable monomer to be combined. The difference in the refractive indices between the dopant and the polymerizable monomer is preferably 0.005 or more. The dopant has the feature to increase the refractive index of the polymer, compared to one that does not include the dopant. In comparison of the polymers produced from the monomers as described in Japanese Patent Publication No. 3332922 and Japanese Patent Laid-Open Publication No. 5-173026, the dopant has the feature that the difference in solution parameter is 7 (cal/cm³)^{1/2} or smaller, and the difference in the refractive index is 0.001 or higher. Any materials having such features may be used as the dopant if such material can change the refractive index and stably exists with the polymers, and the material is stable under the polymerizing condition (such as temperature and pressure conditions) of the polymerizable monomers as described above.

This embodiment shows the method to form a refractive index profile in the core by controlling the direction of polymerization by interface gel polymerizing method, and by providing concentration gradation of the refractive index control agent as the dopant during the process to form the core part from the polymerizable composition mixed with the dopant. Hereinafter, the core having the refractive index profile will be referred to as “graded index core”. Such graded index core is used for the graded index type plastic optical fiber (GI type POF) having a wide range of transmission band.

The dopant may be polymerizable composition, and in that case, it is preferable that the copolymer having the dopant as copolymerized component increases the refractive index in comparison of the polymer without the dopant. An example of such copolymer is MMA-BzMA copolymer.

As described in Japanese Patent Publication No. 3332922 and Japanese Patent Laid-Open Publication No. 11-142657, examples of the dopants are benzyl benzoate (BEN); diphenyl sulfide (DPS); triphenyl phosphate (TPP); benzyl n-butyl phthalate (BBP); diphenyl phthalate (DPP); diphenyl (DP), diphenylmethane (DPM); tricresyl phosphate (TCP); diphenylsoufoxide (DPSO); diphenyl sulfide derivative; dithiane derivative. Among them, BEN, DPS, TPP, DPSO, diphenyl sulfide derivative and dithiane derivative are preferable. In order to improve the transparency in a longer wavelength range, it is possible to use the compounds in which the hydrogen atom is substituted by the deuterium. Example of the polymerizable composition is tribromophenyl methacrylate. A polymerizable composition as the dopant is advantageous in heat resistance although it would be difficult to control various properties (especially optical property) because of copolymerization of polymerizable monomer and polymerizable dopant.

It is possible to control the refractive index of the POF by controlling the density and distribution of the refractive index control agent to be mixed with the core. The amount of the refractive index control agent may be appropriately chosen in accordance with the purpose of the POF, the core material, and the like. More than one kind of the refractive index control agents can be added.

(Other Additives)

Other additives may be contained in the core part and the clad part so far as the transmittance properties do not decrease. For example, the additives may be used for increasing resistance of climate and durability. Further, induced emissive functional compounds may be added for amplifying the optical signal. When such compounds are added to the monomers, weak signal light is amplified by excitation light so that the transmission distance increases. Therefore, the optical member with such additive may be used as an optical fiber amplifier. These additives may be contained in the core part and/or the clad part by polymerizing the additives with the monomers.

(Method for Manufacturing Preform)

The method for manufacturing a graded index type plastic optical fiber base body having the core part and the clad part will be described as a preferable structure of the present invention. The following two structures do not limit the present invention.

In manufacturing the plastic optical fiber of the first structure, the polymerizable compositions for the clad part are polymerized to form a hollow pipe (1st process). Instead, the hollow cylindrical pipe is formed by melt extrusion of thermoplastic resin. The core part is formed by interfacial gel polymerization of the polymerizable composition for the core part in the hollow cylindrical pipe, so the preform having the core part and the clad part is produced (2nd process). The preform is subject to change its shape by the method and apparatus according to the present invention (3rd process) to manufacture the POF.

In manufacturing the second structure of the plastic optical fiber, the outer core part is formed inside the hollow pipe corresponding to the clad part of the first structure (1'st process). In this structure, the core part located in the center of the preform is referred to as the inner core part. In the following description, the term “core part” also indicates the “inner core part”.

For instance, the hollow cylindrical pipe is formed from resin including fluorine, such as polyvinylidene fluoride. The cylindrical pipe including two layers is produced by forming the outer core layer inside the single layer cylindrical pipe by rotational polymerization of the polymerizable composition for the outer core (1'st process). Then, the inner core part is formed in the hollowed area of the double layer cylindrical pipe by the interfacial gel polymerization of the polymerizable composition for the inner core part (2'nd process), so the preform is prepared. After changing the shape of the preform appropriately (3rd process), the POF as the optical member is manufactured.

Although the double layered cylindrical pipe according to the second structure is formed step by step as described above, it is possible to form the double layered cylindrical pipe by a single step of melt extrusion of fluorine containing resin for the clad part and the polymerizable composition for the outer core part.

The composition of the polymerizable monomer for the clad part is preferably the same as that for the core part according to the first structure. In the second structure, the composition of the polymerizable monomer for the outer core part is preferably the same as that for the inner core part. The composition ratio of the polymerizable monomer is not necessary the same, and an accessory ingredient to be added to the polymerizable monomer is not necessary the same. Providing the same kinds off the polymerizable monomer can improve the optical transmittance and the adhesiveness at the interface between the clad part and the core part (or at the interface between the outer core part and the inner core part). When the resin of the clad part or the outer core part is copolymer in which the component thereof has different refractive indices, it is easily possible to provide a large difference in the refractive index between the core part and the clad part (or the inner core part). As a result, the graded index structure is easily provided.

In the second structure, the outer core layer between the clad part and the core part can prevent to decrease the adhesiveness and the productivity of the POF caused by the difference of the materials for the clad part and the core part. Thus, it is possible to increase the kinds of the materials that can be used for the clad part and the core part. The thickness and the diameter of the cylindrical pipe corresponding to the clad part can be controlled in the melt extrusion process of commercial fluorine resin or in the polymerization process of the rotationally polymerizable composition. In the hollow area of cylindrical pipe, the polymerizable composition for the outer core part is subject to rotational polymerization, so the outer core part is formed inside the cylindrical pipe. The same structure may be formed by co-extrusion of the copolymer composed of the fluorine resin and the polymerizable composition.

In these preferable structures, the GI type POF is manufactured by providing the concentration profile of the refractive index control agent, the present invention is also applicable to other type of POF. In addition, the concentration profile of the refractive index control agent may be provided by interfacial gel polymerization and rotational gel polymerization, which will be described later.

The preferable amount of the ingredients of the polymerizable composition for the clad part, the outer core part and the inner core part can be determined in accordance of the kind of the ingredients. In general, the amount of the polymerization initiator is preferably 0.005 wt % to 0.5 wt % of the polymerizable monomer, and more preferably 0.01 wt % to 0.5 wt %. The amount of the chain transfer agent is preferably 0.10 wt % to 1.0 wt % of the polymerizable monomer, and more preferably 0.15 wt % to 0.50 wt %. The amount of the refractive index control agent is preferably 1 wt % to 30 wt % of the polymerizable monomer, and more preferably 1 wt % to 25 wt %.

In consideration of the drawing process of the obtained preform, the weight-average molecular weight of the polymer obtained by polymerizing the polymerizable composition for the clad part, the outer core part and the inner core part is preferably 10,000 to 1,000,000. More preferably, the weight-average molecular weight is 30,000 to 500,000. The drawing property of the preform is affected by the molecular weight distribution (MWD), calculated by dividing weight-average molecular weight by number average molecular weight. The preform having large MWD is not preferable because the portion having extremely high molecular weight exhibits bad drawing property, and what is worse, the preform cannot be drawn. Thus, the value of MWD is preferably 4 or smaller, and more preferably 3 or smaller.

Next, each of the manufacture processes according to the first and second structures (especially the first structures) will be described in detail.

(First Process)

In the first process, the single layered cylindrical pipe for the clad part, or the double layered cylindrical pipe for the clad part and the outer core part is produced. Such cylindrical pipe is produced by polymerizing the monomers and shaping it in a tubular form. For example, the cylindrical pipe is produced by the rotational polymerization and the melt-extrusion of the resin, as described in JP-A Nos. 8-262240, 5-173025 and 2001-215345.

The hollow cylindrical pipe is formed from the polymerizable composition by the rotational polymerization method in which the polymerizable composition is polymerized while rotating the composition to form the polymer layer in a cylindrical polymerization chamber. For example, after the polymerizable composition for the clad part are put in the polymerization chamber, the polymerization chamber is rotated (preferably, the axis of the polymerization chamber is kept horizontally) and the polymerizable composition is polymerized. Thereby, the clad part is formed inside the cylindrical polymerization chamber. Thereafter, the polymerizable composition for the outer core part is put into the clad part, and the composition is polymerized while rotating the clad part. Thereby, the hollow cylindrical pipe having the outer core part on the inner wall of the clad part is formed.

Before putting the polymerizable composition for the clad part or the outer core part, the polymerizable composition is preferably filtered to remove dust contained in the polymerizable composition. Moreover, it is possible to adjust the viscosity of the raw materials (polymerizable composition) for handling with ease, as disclosed in JP-A 10-293215, and to carry out pre-polymerization for shorting the polymerization period, as long as these processes do not cause deterioration in the quality of the preform and the preliminary or post process do not become complicated. The temperature and the period for the polymerization process are determined in accordance with the monomer and the polymerization initiator to be used for polymerization. Generally, the preferable polymerization period is 5 hours to 24 hours. The preferable polymerization temperature is 60° C. to 150° C. As described in JP-A No. 08-110419, the raw materials may be subject to the preliminary polymerization for increasing its viscosity. Such preliminary polymerization can shorten the polymerization period for forming the cylindrical pipe. The polymerization chamber is preferably a metal or glass chamber with high rigidity, because the cylindrical polymer pipe is distorted if the polymerization chamber is deformed in rotation.

The cylindrical pipe may be formed from pelletized or powdered resin (preferably fluorine resin). After sealing both ends of the cylindrical polymerization chamber containing the pelletized or powdered resin, the polymerization chamber is rotated (preferably, the axis of the polymerization chamber is kept horizontally). Then, by heating the resin at a temperature more than the melting point of the resin, the hollow cylindrical polymer pipe is manufactured. In order to prevent heat, oxidization and decompression by thermal oxidization of the molten resin, the polymerization chamber is preferably filled with inert gas such as nitrogen gas, carbon dioxide gas, argon gas, and so forth. Moreover, it is preferable to dry the resin sufficiently before the polymerization process.

In the event of forming the clad part by extruding the molten polymer, the shape of the polymer (cylindrical shape in this embodiment) after polymerization is appropriately controlled by use of molding technique like extrusion. The apparatus for the melt extrusion of the polymer has two types, the inner sizing die type and the outer die decompression absorption type.

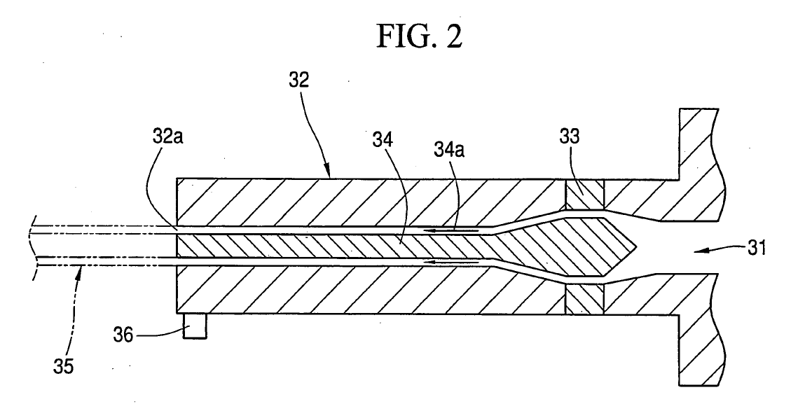

Referring to FIG. 2, the melt extrusion apparatus of the inner sizing die type is described. In the melt extrusion apparatus, a single screw extruder (not illustrated) extrudes a raw polymer 31 for the clad part to a die body 32. In the die body 32, a guide member 33 for changing the shape of the raw polymer 31 into the cylindrical shape is provided. Through the guide member 33, the raw polymer 31 passes a flowing passage 34a between the die body 32 and an inner rod 34. The raw polymer 31 is extruded from an outlet 32a of the die body 32 so that a clad part 35 having the hollow cylindrical pipe is formed. Although there is no limitation in the extrusion speed of the clad part 35, in terms of productivity and the uniformity of the clad part 35, the extrusion speed is preferably 1 cm/min to 100 cm/min.

The die body 32 preferably comprises a heater for heating the raw polymer 31. For instance, one or more heater (for instance, heat generating device by use of steam, thermal oil and an electric heater) are provided along the flowing passage 34a so as to coat the die body 32. A thermometer 36 is provided in the vicinity of the outlet 32a of the die body 32. In order to control the heating temperature, the thermometer 36 measures the temperature of the clad part 35 near the outlet 32a.

The heating temperature in the die body 32 is not limited. Concretely, when the raw polymer 31 is PVDF, the heating temperature is preferably 200° C. to 290° C. The temperature of the clad part 35 is preferably 40° C. or higher because of reducing the change of the clad shape by rapid temperature change. The temperature of the clad 35 may be controlled by a thermostat (for example, a cooler device that utilizes liquid like water, an anti-freezing solution and oil, and an electric cooling device) that is fixed to the die body 32. The clad 35 may be cooled by use of natural cooling of the die body 32. When the heater device is provided with the die body 32, the cooler device is preferably provided in the downstream side of the heater device with respect to the direction to flow the raw polymer 31.

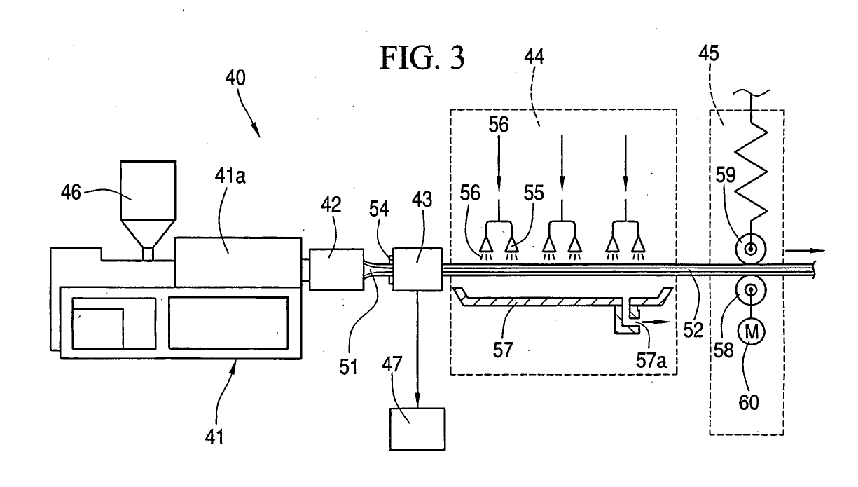

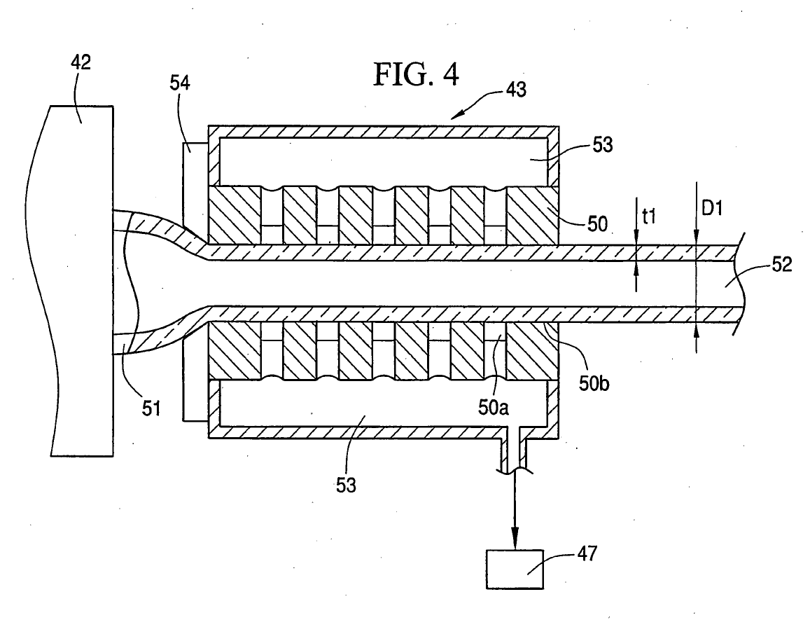

Referring to FIGS. 3 and 4, the melt extrusion apparatus of the outer die decompression absorption type is described. FIG. 3 shows an embodiment of a manufacture line 40 including the melt extrusion apparatus. In FIG. 4, a cross section of a molding die 43 in the manufacture line 40 is illustrated. Referring to FIG. 3, the manufacture line 40 comprises a melt extrusion apparatus 41, an extrusion die 42, a molding die 43, a cooler device 44 and a feeding machine 45. The raw polymer supplied from a pellet casting hopper 46 is melted in a melting section 41a provided in the melt extrusion apparatus 41. The molten polymer is extruded by the extrusion die 42, and then supplied to the molding die 43. The molding die 43 is connected with a vacuum pump 47. The extrusion speed S (m/min) is preferably 0.1 (m/min) to 10 (m/min), more preferably 0.3 (m/min) to 5.0 (m/min), and most preferably 0.4 (m/min) to 1.0 (m/min). The extrusion speed S (m/min) is not limited to the preferable range mentioned above.

As shown in FIG. 4; the molding die 43 has a molding pipe 50 through which the raw polymer is shaped to form the hollow cylindrical clad 52. There are plural suction holes 50a in the molding pipe 50. The suction holes 50a are connected to a decompression chamber 53, provided outside of the molding pipe 50. When the decompression chamber 53 is decompressed by the vacuum pump 47, the outer wall of the clad 52 comes in close contact with the molding surface (inner surface) of the molding pipe 50, so the thickness of the clad 52 becomes uniform. The pressure in the decompression chamber 53 (absolute pressure) is preferably 20 kPa to 50 kPa, but not limited to this range. In order to regulate the diameter of the clad 52, a throat member (diameter regulation member) 54 is preferably fixed at the entrance of the molding die 43.

The clad 52 through the molding die 43 for shaping is fed to the cooling device 44, in which plural nozzles 55 are provided for spraying cooling water 56 to the clad 52. Thereby, the clad 52 is cooled and becomes solidified. The sprayed cooling water 56 is collected in a water receiver 57, and then ejected through a drain opening 57a. The clad 52 is drawn from the cooling device 44 toward the winding machine 45. The winding machine 45 comprises a drive roller 58 and a pressure roller 59. The winding speed by the feeding machine 45 is controlled by a motor 60 that is connected to the drive roller 58. The clad 52 is sandwiched between the drive roller 58 and the pressure roller 59. The extrusion speed is adjusted by the molding die 43. Moreover the feeding speed of the clad 52 is adjusted by the drive roller 58 and the feeding position of the clad 52 is adjusted by the pressure roller 59. Thereby, it is possible to keep the shape and the thickness of the clad 52. If necessary, the drive roller 58 and the pressure roller 59 may be belt-shaped.

The clad may be composed of plural layers for the purpose of providing functions such as the mechanical strength and incombustibility. In addition, after the hollow cylindrical pipe having the arithmetic average roughness of ascertain range is formed, the outer surface of the cylindrical pipe may be coated with fluorine resin or the like.

The outer diameter D1 of the clad 52 (corresponding to the outer diameter of the preform 15) is preferably 10 mm to 100 mm, in consideration of the optical property and the productivity. More preferably, the diameter D1 is between 20 mm to 50 mm. The thickness t1 of the clad 52 can be small as long as the clad 52 can keep its shape. The thickness t1 is preferably 0.3 mm to 20 mm, and more preferably 0.5 mm to 15 mm. These numerical ranges of the outer diameter D1 and the thickness t1 do not limit the present invention.

Examples of the polymerizable monomers as the raw material of the outer core layer are the same as those of the inner core part. The outer core layer is mainly for forming the inner core part, so the thickness of the outer core layer may be small as long as the inner core part can be bulk polymerized. The outer core layer may be merged with the inner core part to form a single core part after the bulk polymerization of the inner core part. Thus, the lower limit of the thickness t2 of the outer core layer before the bulk polymerization is preferably 0.5 mm to 1.0 mm. The upper limit of the thickness t2 may be selected in accordance with the size of the preform, as long as the inner core part has a refractive index profile.

The single or double layered cylindrical structure formed from a polymer preferably has a bottom part to close one end of the cylindrical structure for putting the polymerizable composition as the raw material of the core part (inner core part). It is preferable that the bottom part is formed from a material having excellent adhesion and fitness to the polymer of the cylindrical pipe. The bottom part may be formed from the same polymer as the cylindrical structure. The polymer bottom part is formed, for example, by polymerizing a small amount of the polymerizable monomer injected in the polymerization chamber that is kept vertically before rotating the polymerization chamber for polymerization or after forming the hollow cylindrical pipe. It is possible to plug one end of the cylindrical pipe with a material that is chemically stable so as not to melt into the polymerizable composition for the inner core part, or not to affect the polymerization process of the inner core part.

For the purpose of promoting reaction of the remaining monomers and the polymerization initiators after the rotational polymerization, the hollow polymer pipe may be heated at a temperature higher than the temperature in the rotational polymerization process. After the hollow polymer pipe is formed, non-polymerized compound may be ejected.

(Second Process)

In the second process, the polymerizable monomer in the polymerizable composition filled in the hollow polymer pipe is polymerized to form the core part (inner core part). In the interfacial gel polymerization, the polymerizable monomer is polymerized from the inner wall of the hollow pipe toward the center thereof. When more than one kind of the polymerizable monomer is used, the monomer with higher affinity with the polymer of the hollow pipe is initially polymerized so that such monomer is localized near the inner wall of the hollow pipe. The proportion of the monomer with higher affinity decreases from the surface to the center, while the proportion of other monomer increases. In this way, the proportion of the monomer is gradually changed in the area corresponding to the core part, so the refractive index profile is introduced.

When the monomer with the refractive index control agent is polymerized, the core liquid solidifies the inner wall of the hollow pipe, and the polymers in the inner wall is swelled to form a gel, as described in Japanese Patent No. 3332922. During the polymerization, the monomer with higher affinity to the hollow pipe is localized in the area near the inner wall of the hollow pipe. Thus, the concentration of the refractive index control agent of the polymer becomes smaller in the area near the inner wall of the hollow pipe, and the concentration of the refractive index control agent increases from the surface to the center of the core part. In this way, the concentration profile of the refractive index control agent is generated, and thus the refractive index profile is provided in the core part.

The speed and the degree of polymerization of the polymerizable monomers are adjusted by the polymerization initiators and the chain transfer agent to be added if necessary, and thereby the molecular weight of the polymer is adjusted. For instance, in the event of forming the POF by drawing the polymer, by adjusting the molecular weight (preferably 10,000 to 1,000,000, and more preferably 30,000 to 500,000) by use of the chain transfer agent, the mechanical property in the drawing process becomes in a desirable range. Accordingly, the productivity of the POF is improved.

In the second process, the refractive index profile is introduced in the area corresponding to the core part, but the thermal behavior of the polymer changes according to the refractive index. Thus, when the monomers in the core part are polymerized at the same temperature, the response of the volume shrinkage in polymerization becomes different over the area corresponding to the core part due to the difference in thermal behavior. Thus, bubbles are mixed in the preform. It is also possible that microscopic gap is generated in the preform, and that the bubbles are generated in heating and drawing the preform. Too low polymerization temperature causes decrease of the polymerization efficiency. Moreover, when the polymerization temperature is too low, the productivity of the preform becomes worse, and the optical transmittance of the manufactured optical part becomes worse due to low optical transparency caused by improper polymerization. On the other hand, if the initial polymerization temperature is too high, the initial polymerization speed is excessively increased. As a result, since the polymer cannot be relaxed to the volume shrinkage in the area of the core part, the bubbles are easily generated in the preform.

In order to prevent the above problems, it is preferable to keep the initial polymerization temperature T1 (° C.) within the following range:

(Tb−10)° C.≦T1(° C.)≦Tg(° C.)

It is to be noted that Tb is the boiling point of the polymerizable monomer, and Tg is the glass transition point (glass transition temperature) of the polymer of the polymerizable monomer. The polymerization speed becomes small by setting the initial polymerization temperature T1 within the above range, so it is possible to improve the relaxation property of the polymer to the volume shrinkage during the initial polymerization.

After the initial polymerization at the temperature T1, the monomer is polymerized at the temperature T2 (° C.) that satisfies the following condition:

Tg(° C.)≦T2(° C.)≦(Tg+40)(° C.)

T1(° C.)<T2(° C.)

By completing the polymerization after increasing the temperature from T1 to T2, it is possible to prevent deterioration in the optical transparency, and thus to obtain the preform with excellent optical transmittance. In addition, the effect of thermal deterioration and depolymerization of the preform becomes smaller, and it is possible to decrease deviation in the polymer density in the preform, and to improve the transparency of the preform. The polymerization temperature T2 (° C.) is preferably Tg (° C.) to (Tg+30)° C., and more preferably about (Tg+10)° C. The polymerization temperature T2 of less than Tg (° C.) cannot obtain such effect. When the polymerization temperature T2 is more than (Tg+40)° C., the transparency of the preform will decrease because of thermal deterioration and depolymerization. Moreover, in forming the graded index type core part, the refractive index profile in the core part is destroyed, so the properties of the POF are largely decreased.

The polymerizable monomer is preferably polymerized at the polymerization temperature T2 until the polymerization is completed so that the polymerization initiators do not remain. If non-reacted polymerization initiators remaining in the preform are heated in processing the preform, especially in melt-drawing process, polymerization initiators are decompressed to generate the bubbles in the preform. So it is preferable that the polymerization initiators are completely reacted. The period of polymerization at the polymerization temperature T2 is preferably equal to or more than the half-life of the polymerization initiators at the temperature T2, although the preferable polymerization period depends on the kind of the polymerization initiators.

The polymerization initiator is preferably a chemical having the ten-hour half-life temperature of equal to or more than (Tb−20)° C., wherein Tb is the boiling point of the polymerizable monomer. Polymerizing the monomer with the polymerization initiator that has the ten-hour half-life temperature of equal to or more than (Tb−20)° C. at the initial polymerization temperature T1 (° C.) can decrease the polymerization speed at the initial stage. In addition, it is preferable to polymerize the monomers at the initial polymerization temperature T1 (° C.) satisfying the above condition for a period equal to or more than 10% of the half-life of the polymerization initiator. Thereby, the polymer can quickly relax to the volume shrinkage by a pressure during the initial polymerization. Setting the above described conditions can decrease the initial polymerization speed, and improves the response to the volume shrinkage in the initial polymerization. As a result, since the amount of the bubbles to be introduced to the preform by the volume shrinkage is decreased, it is possible to improve the productivity. It is to be noted that the ten-hour half-life temperature of the polymerization initiator is the temperature in which the amount of the polymerization initiator becomes half in ten hours by decomposition.

In polymerizing the monomer with the polymerization initiator satisfying the above conditions at the initial polymerization temperature T1 (° C.) for a period of equal to or more than 10% of the half-life of the polymerization initiator, it is possible to keep the initial polymerization temperature T1 (° C.) until the polymerization is completed. But in order to obtain the optical member having high optical transparency, completing the polymerization at the polymerization temperature T2 (° C.) that is higher than the initial polymerization temperature T1 (° C.) is preferable. The preferable temperature of the polymerization temperature T2 (° C.) and the period for polymerization at the temperature T2 (° C.) are mentioned above.

When methyl methacrylate (MMA) with the boiling point Tb of 100 (° C.) is used as the polymerizable monomer in the second process, PBD and PHV can be used as the polymerization initiator with the ten-hour half-life temperature of (Tb−20) ° C. or higher. For example, when MMA is used as the polymerizable monomer and PBD is used as the polymerization initiator, it is preferable to keep the initial polymerization temperature T1 (° C.) at 100-110° C. for 48-72 hours, to increase the temperature to the polymerization temperature T2 (° C.) of 120-140° C., and to carry out polymerization at T2 (° C.) for 24-48 hours. In the event of using PHV as the polymerization initiator, it is preferable to keep the initial polymerization temperature T1 (° C.) at 100-110° C. for 4-24 hours, to increase the temperature to the polymerization temperature T2 (° C.) of 120-140° C., and to carry out polymerization at T2 (° C.) for 24-48 hours. The temperature in the polymerization may be increased step by step or continuously. It is preferable to increase the temperature in the polymerization as quickly as possible.

In the second process, the pressure in the polymerization may be increased or decreased, as described in JP-A No. 09-269424 or Japanese Patent No. 3332922. Moreover, the pressure can be changed during the polymerization. By changing the pressure in the polymerization, it is possible to improve polymerization efficiency at the initial polymerization temperature V1 (° C.), near the boiling point Tb (° C.) and satisfying the above condition, and the polymerization temperature T2 (° C.). In polymerizing the monomer with a pressurized condition (pressurized polymerization), the hollow pipe containing the polymerizable monomer is preferably supported in a hollow portion of a jig. Moreover, carrying out dehydration and degassing in a low pressure condition before polymerization can effectively decrease the bubbles to be generated.

The jig to support the hollow pipe is provided with a hollow part for inserting the above described hollow pipe, and the hollow part of the jig preferably has the same shape as the hollow pipe. In other words, the jig preferably has a hollow cylindrical shape. The jig can prevent deformation of the hollow pipe during the pressurized polymerization, and can support the hollow pipe enough to relax the shrinkage of the core part as the pressurized polymerization proceeds. Accordingly, the diameter of the hollow part of the jig is preferably larger than the diameter of the hollow pipe, so the hollow pipe in the jig does not come in contact with the inner wall of the hollow pipe. Compared to the outer diameter of the hollow pipe, the diameter of the hollow part is preferably larger by 0.1% to 40% of the outer diameter of the hollow pipe, and more preferably larger by 10% to 20% of the outer diameter of the hollow pipe.

The jig containing the hollow pipe is set in the polymerization chamber. The longitudinal direction of the hollow pipe in the polymerization chamber is preferably held vertically. After setting the hollow pipe supported by the jig in the polymerization chamber, the polymerization chamber is subject to pressurization. In proceeding pressurized polymerization, the polymerization chamber is preferably pressurized in the atmosphere of inert gas like nitrogen gas. The pressure (gauge pressure) in polymerization is preferably 0.05 MPa to 1.0 MPa in general, although the preferable pressure depends on the type of the monomer to be polymerized.

The method to manufacture the core part is not limited to the above described process. For instance, the inner core (core part) may be formed by rotational polymerization method to carry out interfacial gel polymerization in rotating the monomer for the core part. In the following explanation, the inner core is formed. In the clad pipe having the outer core, the inner core solution is injected. Then, after sealing one end of the clad pipe, the clad pipe is kept in the polymerization chamber horizontally (in the state in which the longitudinal direction of the clad pipe is kept horizontally), the inner core solution is subject to polymerization while the clad pipe is rotated. The inner core solution may be injected collectively, continuously or successively in the clad pipe. Instead of the GI type POF, a multi step type optical fiber having step-shape refractive index profile by adjusting the amount, composition and polymerization degree of the inner core polymerizable composition. In the preferred embodiment, the above described method of polymerization is referred to as the core part rotational polymerization method (core part rotational gel polymerization method).

Compared with the interfacial gel polymerization, the rotational polymerization method can discharge the bubbles to be generated from the core solution because the core solution has larger surface area than the gel. Therefore, the bubbles in the produced preform decreases. In addition, forming the core part by the rotational polymerization method, the preform may have a void in the center. In such case, the void in the preform is filled by the melt-drawing process to manufacture a plastic optical member such as the POF. Such preform can be utilized as other type of the optical member such as the plastic lens by closing the void in the preform in the melt-drawing process.

The amount of the bubbles to be generated after the polymerization process can be decreased by cooling the preform at a constant cooling speed under the control of the pressure at the stage to complete the second process. In terms of the pressure response of the core part, the pressure polymerization of the core part in the atmosphere of nitrogen gas is preferable. But it is impossible to completely discharge the gas from the preform, and the cooling process will cause rapid shrinkage of the polymer so that the bubble are generated due to the bubble nucleus formed by gas accumulation to the void in the preform. In order to prevent such problem, it is preferable to control the cooling speed. The cooling speed is preferably 0.001° C./min to 3° C./min, more preferably 0.01° C./min to 1° C./min. The cooling process can be carried out by two steps or more in accordance with the progress of the volume shrinkage of the polymer in the core part in changing the temperature to the glass transition temperature Tg (° C.). In that case, it is preferable to set a high cooling speed just after polymerization and then gradually reduce the cooling speed.

The preform after the above described processes has uniform refractive index distribution and sufficient optical transparency. In addition, the amount of the bubbles and microscopic void is reduced. The flatness of the interface between the clad part (or the outer core part) and the core part becomes excellent. Although the above manufacture method describes the cylindrical preform with a single outer core layer, the outer core part having two or more layers may be formed. After the optical fiber is manufactured by the interfacial gel polymerization and the drawing processes, the outer core part may be integrated with the inner core part.

In FIG. 5A, the cross section of the preform 15 is illustrated. For the purpose of obtaining excellent transmittance, the inner core 20b is preferably the graded index type (GI type) in which the refractive index decreases from the center to the periphery (see FIG. 5B). The outer core 20a is formed from a material capable of interfacial gel polymerization in forming the inner core 20b. The shape of the preform 15 is not limited. The outer diameter D1 (mm) of the clad pipe 12 is preferably 10 mm to 100 mm, and the thickness t1 of the clad pipe 12 is preferably 0.5 mm to 15 mm. The POF 17 with the outer diameter D1 of less than 10 mm causes to decrease productivity. On the other hand, when the outer diameter D1 of the POF 17 is more than 100 mm, makes it difficult to perform the melt-drawing of the preform 15. In the interface gel polymerization, it is preferable to form the inner core 20b with the diameter D2 (mm) of 2 mm to 15 mm after forming the outer core having the thickness t2 (mm) of 2 mm to 15 mm.

Various kinds of the plastic optical members can be manufactured by processing the preform. For instance, slicing the preform in the direction perpendicular to the longitudinal direction can manufacture disk-shaped or cylindrical shaped lenses with flat surfaces. The POF can be manufactured by melt-drawing the preform. When the core part of the preform has refractive index profile, the POF with uniform optical transmittance can be stably manufactured with high productivity.

(Third Process)

In the melt-drawing as the third process, the preform is heated and melted through a heating chamber (cylindrical heating chamber, for example), and drawing the molten preform. The heating temperature can be determined in accordance with the material of the preform. In general, the heating temperature is preferably 180° C. to 250° C. The drawing condition (such as the drawing temperature) can be determined in accordance with the materials and the diameter of the POF. In forming the GI type POF having the refractive index profile in the core part, it is necessary to carry out the drawing process evenly in the radial direction of the POF, in order not to destroy the refractive index profile. Thus, the cylindrical heater capable of heating the preform uniformly over the section thereof is preferably used for the heating process. The heating chamber preferably has a distribution in the temperature in the drawing direction of the preform. In order to prevent to destroy the refractive index profile, the heating area in the preform is preferably as small as possible. In other words, it is preferable to carry out preheat process at the position before the heating area, and to carry out cooling process at the position after the heating area. The heating device for the heating process may be a laser device that can supply high energy in a small heating area.

The drawing apparatus for the drawing process preferably has a core position adjusting mechanism to keep the position of the core, in order to keep the circularity of the preform. It is possible to control the orientation of the polymer of the POF by adjusting the drawing condition, and thus possible to control the mechanical property (such as the bending quality), thermal shrinkage, and so forth.

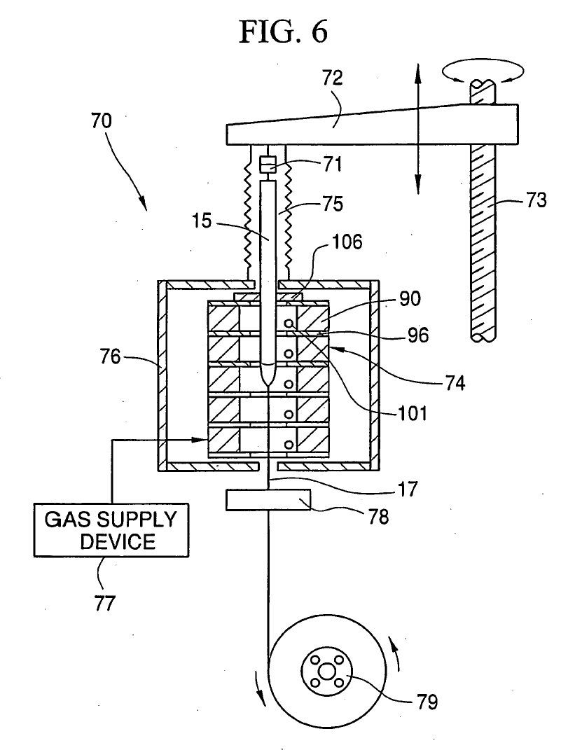

In FIG. 6, manufacture equipment 70 for manufacturing the POF 17 is illustrated. The preform 15 is supported by a vertical movement arm 72 (hereinafter referred to as “arm”) 72 through an X-Y alignment device 71. The arm 72 is vertically movable by the rotation of a vertical movement screw 73 (hereinafter referred to as “screw”). When the screw 73 is rotated to move the arm 72 downward slowly (for example, 1 mm/min to 20 mm/min), the lower end of the preform 15 enters a hollow cylindrical heating furnace 74. The particulars of the heating furnace will be described later. The preform 15 is melted and drawn little by little from the lower end thereof, and the POF 17 is formed. The whole surface of the preform 15 is preferably coated with a flexible cylinder 75 that shields external dust and airflow from the preform 15 for the purpose of keeping the atmosphere in the vicinity of the preform 15 before the heating process. The flexible cylinder 75 having the upper end portion of a dead-end structure is preferable because of reducing an updraft from the heating furnace 74. The heating furnace 74 is stored in a heating furnace chamber 76 to keep the heating furnace 74 from external atmosphere. Thereby, it is possible to keep the atmosphere in the area to pass the preform 15. In addition, it is preferable to provide a gas supply device 77 to make the heating furnace 74 in an inert gas atmosphere.

The diameter of the manufactured POF 17 is measured by use of a diameter measure device 78. Based on the measured diameter, the moving speed of the arm 72, the heating temperature of the heating furnace 74, the drawing speed of the POF 17, and so forth, are controlled such that the diameter of the POF 17 becomes a set value. In order to decrease the transmission loss caused by fluctuation in the diameter of the POF, the control system for controlling the diameter is preferably fast-responsive. In the manufacture equipment 70 of FIG. 6, the diameter of the POF 17 is controlled by adjusting the winding speed of a winding reel 79. It is also possible to control the diameter by other parts in the manufacture equipment. For instance, when the preform is heated by use of a fast-response heating device such as a laser device, the heating energy of the laser device may be controlled. Lastly, the POF 17 is wound around the winding reel 79.

As described in JP-A No. 7-234322, the tension in the drawing process (drawing tension) is preferably 0.098 N (10 g) or more. In order not to leave distortion in the POF 17 after the melt-drawing process, the drawing tension is preferably 0.98 N (100 g) or less, as described in JP-A No. 7-234324. Since the drawing tension changes in accordance with the diameter and the material for the POF, the drawing tension is not limited to the above conditions. It is possible to carry out preliminary heating process in the melt-drawing, as described in JP-A No. 8-106015. The bending and lateral pressure properties of the POF improve by setting the elongation break and the hardness of the manufactured POF, as described in JP-A No. 8-54521. Moreover, the transmission property of the POF improves by providing a low refractive index layer as the reflection layer around the POF.

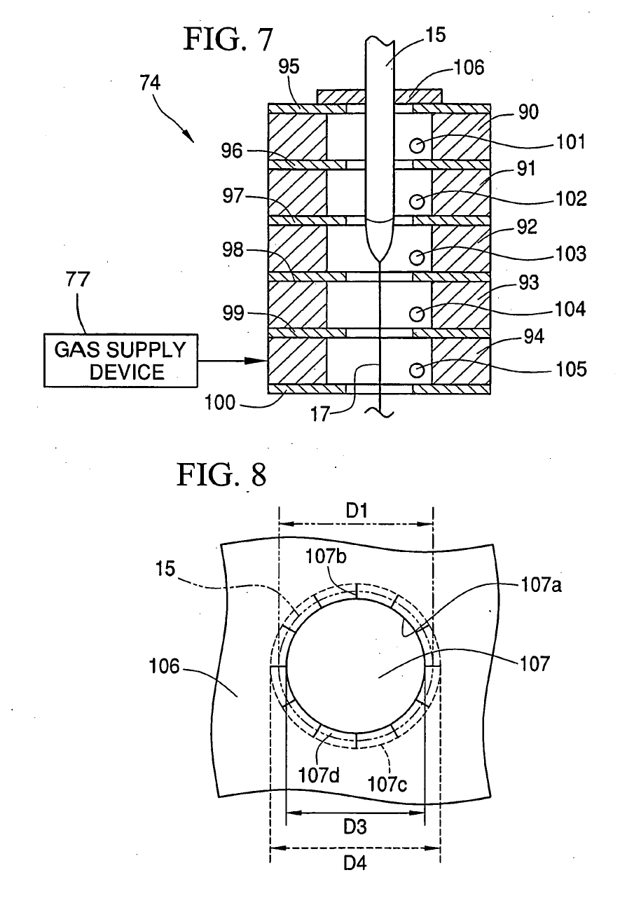

In FIG. 7, the heating furnace 74 is illustrated. The gas supply device 77 supplies inert gas to set the heating furnace 74 in the inert gas atmosphere. The heating furnace 74 comprises five heater units 90, 91, 92, 93 and 94 that are piled along the direction to draw the preform 15. The number of the heater units is not limited to five. The heating furnace 74 preferably has 2 heater units to 10 heater units, more preferably 3 units to 8 units. Although one gas supply device 77 is connected to the heating furnace 74, plural gas supply devices 77 may be provided for each of the heater units 90-93. One gas supply device may be provided for plural heater units. As for the gas to be supplied to the heating furnace 74, nitrogen gas (thermal conductivity: 0.0242 W/(m·K)) and rare gas such as helium gas (thermal conductivity: 0.1415 W/(m·K)), argon gas (thermal conductivity: 0.0015 W/(m·K)) and neon gas. In terms of the manufacture cost, nitrogen gas is preferably used. In terms of thermal conductivity, helium gas is preferable. A mixture gas, such as a mixture gas of helium and argon, is preferable in obtaining the desirable thermal conductivity and reducing the manufacture cost. The inert gas may be circulated because the inert gas is supplied for the purpose of keeping the heating furnace in an inert gas atmosphere and controlling the thermal conductivity in the heating furnace 74. Circulating inert gas can decrease the manufacture cost. The preferable supply of inert gas depends on the heating condition and the kind of the gas to be supplied. As for helium gas, the supply is preferably 1 L/min to 10 L/min (in a room temperature).

An orifice 95 is provided on the top face of the uppermost heater unit 90. The orifices 96-99 are provided between the adjacent heater units. The orifice 100 is provided on the bottom face of the lowermost heater unit 94. These orifices 95-100 can divide the heating furnace 74 into plural heating sections in which the temperature can be adjusted independently. The heating sections may be provided with thermometers 101-105, respectively. Based on the temperature in each section measured by the thermometers 101-105, the output power of the heater units 90-94 are controlled. A seal member 106 is attached to the top face of the uppermost orifice 95. As shown in FIG. 8, an opening 107 having the diameter D3 (mm) is formed in the seal member 106. The preform 15 enters the heater unit 90 through the opening 107 in the seal member 106.

The seal member 106 exhibits high sealing effect when the seal member 106 comes in contact with the preform 15, so the sealing member 106 needs to have heat-resistance and softness mot to damage the preform 15. As the material of the seal member 106, a carbon felt and a rubber sheet such as a silicon rubber are preferable. A glass and a ceramics having excellent heat-resistance can be used as long as the preform 15 is not damaged.

In order to seal the heating furnace 74 with the preform 15, it is preferable that the diameter D3 (mm) of the opening 107 is smaller than the outer diameter D1 (mm) of the preform 15. Plural out lines 107b are provided in the radial direction outwardly from the edge 107a of the opening 107. The edges of the cut lines 107b are on an opening (outer opening) 107c that has a substantially circular shape. The outer opening 107c has the diameter D4 (mm). The area from the edge 107b of the opening 107 to the outer opening 107c is referred to as a contact area 107d to contact the preform 15. The preform 15 through the seal member 106 comes in contact with the contact area 107d of the seal member 106, so it is possible to seal the top side of the heating furnace 74 by use of the seal member 106. As a result, the heating furnace 74 is kept external air from entering through the opening in the bottom side of the heating furnace 74. Thus, it is possible to control the temperature distribution in the heating furnace 74.

The outer diameter D3 (mm) preferably satisfies the condition of following condition:

0.75×D1(mm)≦D3(mm)≦D1(mm)

More preferably, the outer diameter D3 satisfies the following condition:

0.80×D1(mm)≦D3(mm)≦0.90×D1(mm)

The diameter D4 (mm) of the outer opening 107c satisfies the following condition:

D1(mm)<D4(mm)≦1.50×D1(mm)

More preferably, the outer diameter D4 satisfies the following condition:

1.10×D1(mm)≦D4(mm)≦1.30×D1(mm)

The diameter D3 (mm) of the opening 107 is not necessarily smaller than the diameter D1 (mm) of the preform 15. For example, when the opening 103 having the diameter D3 that satisfies the condition larger than D1 (mm) and equal to or smaller than 1.20×D1 (mm), the seal member 106 can provide sufficient sealing effect In that case, since the seal member 106 does not contact the preform 15, a variety of the materials can be selected as the seal member 106. Since the temperature of the uppermost heating unit 90 is high (150° C. to 290° C., for example), it is preferable to use ceramics having excellent heat-resistance as the material of the seal member 106.

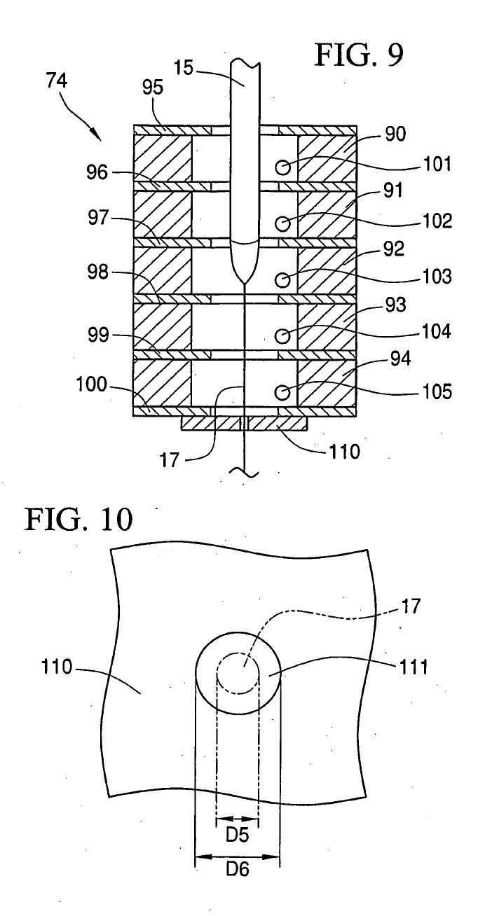

Referring to FIG. 9, a seal member 110 is provided in the downstream side of the heating furnace 74 with respect to the drawing direction of the POF 17. The seal member 110 is attached to the bottom face of the lowermost orifice 100. In FIG. 9, the gas supply device is not illustrated for the purpose of simplifying the drawing. As shown in FIG. 10, an opening 111 is formed in the seal member 110 to pass the POF 17. After the drawn POF 17 has a desirable diameter, the seal member 110 is attached to the bottom face of the orifice 100 while the POF 17 passes the opening 111 in the seal member 110. Thereby, it is possible to prevent turbulence in the temperature of the heating furnace 74 caused by external air from the lower side of the heating furnace 74. The material for the seal member 110 is not limited. But in consideration of easy processing and the manufacture cost, the seal member 110 may be a metal plate (such as stainless plate and aluminum plate). Moreover, the seal member 110 may be a rubber plate or a plastic plate that have enough heat-resistance not to be deformed at a high temperature. Preferably, the seal member 110 is made of a plastic plate with heat-resistance. The temperature of the lowermost heater unit 94 is relatively low (30° C. to 80° C., for example) compared to the temperature of other heater units, so the seal member 110 can be made of plastic that is easily processed.

The diameter D6 (mm) of the opening 111 in the lower seal member 110 is preferably equal to or larger than 1.20×D5 (mm) and equal to or smaller than 10×D5 (mm), and more preferably equal to or larger than 1.50×D5 (mm) and equal to or smaller than 5.0×D5 (mm). It is to be noted that D5 (mm) indicates the outer diameter of the POF 17. For example, when the diameter D5 of the POF 17 is 1.0 mm, the diameter D6 of the opening 111 is preferably 2 mm to 3 mm. If the diameter D6 (mm) is smaller than 1.20×D5 (mm), the POF 17 is easily contacted to the sealing member 110 when the passage of the POF 17 is fluctuated. In that case, the outer surface of the POF 17 is damaged, and thus the optical property of the POF 17 is affected. On the other hand, if the diameter D6 (mm) is larger than 10×D5 (mm), it is difficult or impossible to achieve the effect of the present invention to prevent external air from entering the heating furnace 74.

Instead of forming the opening 111 in the seal member 110, it is possible to attach a shutter-type sealing member capable of changing the diameter D4 (mm). By changing the diameter D4, it is possible to shorten the time for adjusting the setting of the heating furnace 74 in the event of changing the diameter D5 (mm) of the POF 17 to be formed by the melt-drawing process. In addition, the seal member may comprise two blades that can be open and closed. The seal member may be partially separable. In that case, the seal member is partially separated in the beginning of the melt-drawing process, and the separated portion of the seal member is fixed after the diameter of the POF 17 becomes a set value. By use of such seal member, the operation to set the seal member after forming the POF with desirable diameter becomes easier.

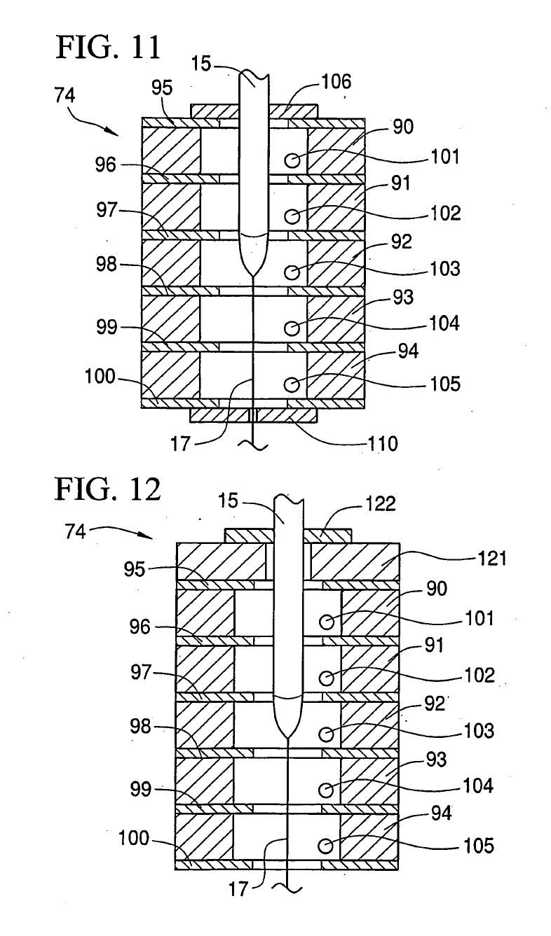

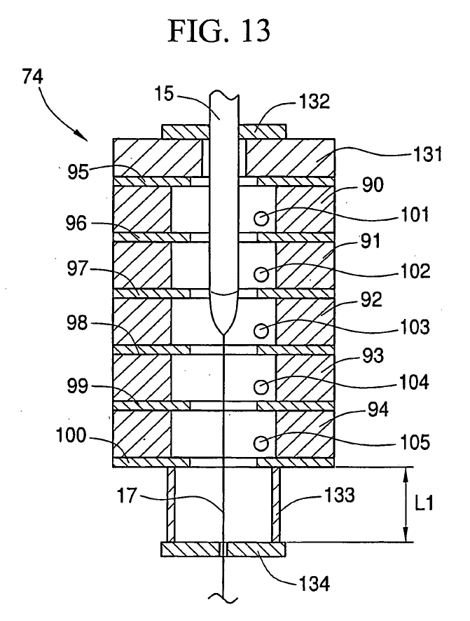

The heating furnace 74 shown in FIG. 11 has the seal members 106, 110 attached to the top and bottom sides of the heating furnace 74. In FIG. 11, the gas supply device is not illustrated for the purpose of simplifying the drawing. Since the seal members are attached on both sides of the heating furnace 74, it is possible to shield the heating furnace 74 from external air in the top and bottom sides. Thus, it is possible to prevent airflow in the heating furnace, and thus to prevent turbulence in the temperature in the heating furnace 74. By controlling the temperature of the heater units 90-94, it is possible to make desirable temperature distribution in the preform 15 and the POF 17, and thus to keep the condition in the melt-drawing process.

The heating furnace 74 in FIG. 12 has a spacer 121 on the uppermost orifice 95. It is to be noted that the gas supply device is not illustrated in FIG. 12. The heater unit 90 for preheating and melting the preform 15 is kept at a high temperature (150° C. to 290° C., for example). A seal member 122 has the shape to coat the outer surface of the preform 15 for the purpose of improving the sealing effect, as described above. Thus, the seal member 122 is preferably made of a soft material not to cause damage, such as scratch, in the surface of the preform 15. Examples of the material of the seal member 122 are a plastic film (preferably an engineering plastic film) such as polyimide resin and PET with certain level of heat-resistance, an elastomer (for example, a silicone rubber, a urethane elastomer and a forming resin). These soft materials for the seal member 122 do not have sufficient heat-resistance, so the seal member 122 on the heated orifice 95 is damaged by heat. Thus, it is preferable to attach the spacer 121 on the orifice and to attach the seal member 122 (same as the seal member 106 of FIG. 6) on the spacer 121. The material of the spacer 121 is not limited, but ceramics with excellent heat-resistance (for example, rock wool and Hemisal) and glass cloth are preferable.

As shown in FIG. 13, a spacer 131 and a seal member 132 are provided with the heating furnace 74. The spacer 131 and the seal member 132 are the same as those illustrated in FIG. 12. Below the lowermost orifice 100, one end of a cylindrical pipe 133 is attached, and a seal member 134 (same as the seal member 110 of FIG. 10) is attached to the other end of the cylindrical pipe 133. The seal member 134 can control airflow in the cylindrical pipe 133. Thereby, it is possible to prevent deformation (such as a line in the surface) of the soft POF 17 just after the melt-drawing process. The length L1 (mm) of the cylindrical pipe 133 is not limited, but the length L1 (mm) is preferably 100 mm to 1000 mm. The inner diameter of the cylindrical pipe 133 is preferably 10 mm to 50 mm. In FIG. 13, the gas supply device is not illustrated for the purpose of simplifying the drawing.

Normally, at least one protective layer is coated with the POF for the purpose of improving flexural and weather resistance, preventing decrease in property by moisture absorption, improving tensile strength, providing resistance to stamping, providing resistance to flame, protecting damage by chemical agents, noise prevention from external light, increasing the value by coloring, and the like.

(Structure of the Coating)

The plastic optical fiber cable (optical fiber cable) is manufactured by coating the POF and/or the optical fiber strand. As for the type of coating, there are a contact type coating in which the coating layer contacts the whole surface of the POF, and a loose type coating in which a gap is provided between the coating layer and the POF. When the coating layer of the loose type is peeled for attaching a connector, it is possible that the moisture enters the gap between the POF and the coating layer and extends in the longitudinal direction of the optical fiber cable. Thus, the contact type coating is preferable.

The loose type coating, however, has the advantage in relaxing the damages caused by stress and heat to the optical fiber cable due to the gap between the coating layer and the POF. Since the damage to the POF decreases, the loose type coating is preferably applied to some purposes. It is possible to shield moisture from entering from the lateral edge of the optical fiber cable by filling gelled or powdered material in the gap. If the gelled or powdered material as the filler is provided with the function of improving heat-resistance and mechanical strength, the coating layer with excellent properties can be realized. The loose type coating layer can be formed by adjusting the position of the extrusion nipple of the cross head die, and by controlling the pressure in a decompression device. The thickness of the gap layer between the POF and the coating layer can be controlled by adjusting the thickness of the nipple and pressure to the gap layer.

Examples of the materials for the protective layers are thermoplastic resin such as polyethylene (PE), polypropylene (PP), vinyl chloride (PVC), ethylene vinylacetate copolymer (EVA), ethylene ethylacrylate copolymer (EEA), polyester and nylon. Besides the thermoplastic resin, kinds of elastomers can be used. The elastomer with high elasticity is effective in providing mechanical strength, such as bending property. Examples of the elastomer are rubbers such as isoprene rubber, butadiene rubber and diene special rubber, fluid rubber such as polydiene and polyorefine, and thermoplastic elastomers. The fluid rubber exhibits fluidity in the room temperature and loses its fluidity by heat to become solid. The thermoplastic elastomer exhibits elasticity in the room temperature, and be plasticized for shaping at a high temperature. It is possible to use a thermally solidified solution of the mixture of polymer precursor and reactive agent, such as one-pack type thermosetting urethane composition that is composed of urethane pre-polymer with NCO group, described in WO/26374, and solid amine having the size of 20 μm or smaller.

The above listed materials do not limit the present invention as long as the materials can be shaped at a temperature lower than the glass transition temperature Tg of the POF polymer. The copolymer of the above listed materials or other materials can be used. In addition, the mixture polymer can be used. For the purpose of improving the properties of the protective layer, additives and fillers may be added. Examples of the additives are incombustibility, antioxidant, radical trapping agent and lubricant. The fillers may be made from organic and/or inorganic compound.

The POF may have a second (or more) protective layer around the above described protective layer as the first protective layer. If the first protective layer has a thickness enough to decrease the thermal damage to the POF, the requirement of the hardening temperature of the second protective layer becomes less strict compared with the first protective layer. The second protective layer may be provided with the additives such as incombustibility, antioxidant, radical trapping agent and lubricant.

The flame retardants are resin with halogen like bromine, an additive and a material with phosphorus. Metal hydroxide is preferably used as the flame retardant for the purpose of reducing toxic gas emission. The metal hydroxide contains water of crystallization, which is not removed during the manufacture of the POF. Thus, it is preferable to provide a moisture proof coat around the first protective layer and to form the metal hydroxide as the flame retardant around the moisture proof coat. As for the standard of the incombustibility, the UL (Underwriters Laboratory) regulates several experiments. The regulations are CMX (combustion experiment is called as VW-1 experiment), CM (vertical tray combustion experiment), CMR (riser experiment), CMP (plenum experiment), from the lower incombustibility in this order listed. Since the plastic optical fiber is formed from a flammable material, the plastic optical fiber cable preferably has the VW-1 regulation for the purpose of preventing fire spread.

The POF may be coated with plural coat layers with multiple functions. Examples of such coat layers are a flame retardant layer described above, a barrier layer to prevent moisture absorption, moisture absorbent (moisture absorption tape or gel, for instance) between the protective layers or in the protective layer, a flexible material layer and a styrene forming layer as shock absorbers to relax stress in bending the POF, a reinforced layer to increase rigidity. The thermoplastic resin as the coat layer may contain structural materials to increase the strength of the optical fiber cable. The structural materials are a tensile strength fiber with high elasticity and/or a metal wire with high rigidity. Examples of the tensile strength fibers are an aramid fiber, a polyester fiber, a polyamide fiber. Examples of the metal wires are stainless wire, a zinc alloy wire, a copper wire. The structural materials are not limited to those listed above. It is also possible to provide other materials such as a metal pipe for protection, a support wire to hold the optical fiber cable. A mechanism to increase working efficiency in wiring the optical fiber cable is also applicable.

In accordance with the way of use, the POF is selectively used as a cable assembly in which the POFs are circularly arranged, a tape core wire in which the POFs are linearly aligned, a cable assembly in which the tape core wires are bundled by using a band or LAP sheath, or the like.

Compared with the conventional optical fiber cable, the optical fiber cable containing the POF according to the present invention has large permissible error in the core position, the optical fiber cables may be connected directly. But it is preferable to ensure to fix the end of the POF as the optical member according to the present invention by using an optical connector. The optical connectors widely available on the market are PN type, SMA type, SMI type and the like.

A system to transmit optical signals through the POF, the optical fiber wire and the optical fiber cable as the optical member comprises optical signal processing devices including optical components, such as a light emitting element, a light receiving element, an optical switch, an optical isolator, an optical integrated circuit, an optical transmitter and receiver module, and the like. Such system may be combined with other POFs. Any know techniques can be applied to the present invention. The techniques are described in, for example, “‘Basic and Practice of Plastic Optical Fiber’ (issued from NTS Inc.)”, “‘Optical members can be Loaded on Printed Wiring Assembly, at Last’ in Nikkei Electronics, vol. Dec. 3, 2001”, pp. 110-127”, and so on. By combining the optical member according to with the techniques in these publications, the optical member is applicable to short-distance optical transmission system that is suitable for high-speed and large capacity data communication and for control under no influence of electromagnetic wave. Concretely, the optical member is applicable to wiring in apparatuses (such as computers and several digital apparatuses), wiring in trains and vessels, optical linking between an optical terminal and a digital device and between digital devices, indoor optical LAN in houses, collective housings, factories, offices, hospitals, schools, and outdoor optical LAN.

Further, other techniques to be combined with the optical transmission system are disclosed, for example, in “‘High-Uniformity Star Coupler Using Diffused Light Transmission’ in IEICE TRANS. ELECTRON., VOL. E84-C, No. 3, MARCH 2001, pp. 339-344”, “‘Interconnection in Technique of Optical Sheet Bath’ in Journal of Japan Institute of Electronics Packaging., Vol. 3, No. 6, 2000, pp. 476-480”. Moreover, there are am optical bus (disclosed in Japanese Patent Laid-Open Publications No. 10-123350, No. 2002-90571, No. 2001-290055 and the like); an optical branching/coupling device (disclosed in Japanese Patent Laid-Open Publications No. 2001-74971, No. 2000-329962, No. 2001-74966, No. 2001-74968, No. 2001-318263, No. 2001-311840 and the like); an optical star coupler (disclosed in Japanese Patent Laid-Open Publications No. 2000-241655); an optical signal transmission device and an optical data bus system (disclosed in Japanese Patent Laid-Open Publications No. 2002-62457, No. 2002-101044, No. 2001-305395 and the like); a processing device of optical signal (disclosed in Japanese Patent Laid-Open Publications No. 2000-23011 and the like); a cross connect system for optical signals (disclosed in Japanese Patent Laid-Open Publications No. 2001-86537 and the like); a light transmitting system (disclosed in Japanese Patent Laid-Open Publications No. 2002-26815 and the like); multi-function system (disclosed in Japanese Patent Laid-Open Publications No. 2001-339554, No. 2001-339555 and the like); and various kinds of optical waveguides, optical branching, optical couplers, optical multiplexers, optical demultiplexers and the like. When the optical system having the optical member according to the present invention is combined with these techniques, it is possible to construct an advanced optical transmission system to send/receive multiplexed optical signals. The optical member according to the present invention is also applicable to other purposes, such as for lighting, energy transmission, illumination, and sensors.

(Experiments)

The present invention will be described in detail with reference to Experiments (1)-(5) as the embodiments of the present invention and Experiment (6) as the comparisons. The materials, contents, operations and the like will be changed so far as these modifications are within the spirit of the present invention. Thus, the scope of the present invention is not limited to the Experiments described below. The description below explains Experiment (1) in detail. Regarding Experiments (2)-(6), the portions different from Experiment (1) will be explained.

(Experiment 1)

The clad pipe 12, formed from polyvinylidene fluoride (PVDF) by extrusion, has the outer diameter D1 of 20 mm, the inner diameter of 19 mm (clad thickness t1 is 0.5 mm), and the length of 900 mm. The clad pipe 12 is inserted in the rigid polymerization chamber having the inner diameter of 20 mm and the length of 1000 mm. After the polymerization chamber containing the clad pipe 12 is washed with pure water, the polymerization chamber is dried under the temperature of 90° C. Thereafter, one end of the clad pipe 12 is sealed by a Teflon® stopper. The inner wall of the clad pipe 12 is washed with ethanol, and then the clad pipe 12 is subject to decompression process (−0.08 MPa to atmospheric pressure) for 12 hours at 80° C. by an over.

Next, the outer core polymerization process 13 is carried out. The outer core solution is prepared in an Erlenmeyer flask. The outer core solution contains deuteriated methylmethacrylate (MMX-d8, produced by Wako Pure Chemical Industries, Ltd.) of 205.0 g, 2-2′-azobis(isobutyric acid) dimethyl of 0.0512 g, and 1-dodecanethiol(laurylmercaptan) of 0.766 g. The outer core solution is subject to ultrasonic irradiation for ten minutes by use of an ultrasonic cleaner USK-3 (38000 MHz, output power of 360 W), manufactured by AS ONE Corporation. Then, after pouring the outer core solution in the clad pipe 12, the clad pipe 12 is subject to decompression of 0.01 MPa to atmospheric pressure by use of a decompression filter machine, and subject to the ultrasonic process for 5 minutes by use of the ultrasonic cleaner.

After substituting the air in the tip of the clad pipe 12 with argon gas, the tip of the clad pipe is tightly sealed with a silicon stopper and a sealing tape. The clad pipe 12 containing the outer core solution is subject to preliminary polymerization for two hours while the clad pipe 12 is shaken in a hot water bath at 60° C. After the preliminary polymerization, the clad pipe 12 is held horizontally (the longitudinal direction of the clad pipe is kept horizontally) and is subject to heat polymerization (rotational polymerization) while rotating the clad pipe 12 at 500 rpm and keeping the temperature at 60° C. Thereafter, the clad pipe 12 is subject to rotational polymerization for 16 hours at 3000 rpm and 60° C., and then for 4 hours at 3000 rpm and 90° C. Thereby, the cylindrical pipe having the outer core 20a of PMMA-d8 inside the clad pipe 12.

The preliminary process for forming the inner core is carried out. The clad pipe 12 having the outer core 20a is subject to decompression process (−0.08 MPa to atmospheric pressure) at 90° C. by an oven. Then, the inner core polymerization process 14 is carried out. The inner core solution, containing deuteriated methylmethacrylate (MMA-d8, produced by Wako Pure Chemical Industries, Ltd.) of 82.0 g, 2-2′-azobis(isobutyric acid) dimethyl of 0.070 g, 1-dodecanethiol(laurylmercaptan) of 0.306 g, and diphenyl sulfide (DPS) as the dopant of 6.00 g, is prepared in an Erlenmeyer flask. Then, the clad pipe 12 is subject to ultrasonic process irradiation for 10 minutes by use of the ultrasonic cleaner USK-3.

After keeping the clad pipe 12 with the outer core 20a for 20 minutes at 80° C., the inner core solution is poured in the hollow part of the clad pipe 12. One end of the clad pipe 12 is coated with a Teflon® stopper. The clad pipe 12 is subject to rotational gel polymerization for 5 hours at the temperature of 70° C. and the rotational speed of 3000 rpm. Then, the clad pipe 12 is subject to heat polymerization and heat process for 24 hours at 120° C. Thereby, the preform 15 having the inner core 20b is produced. The preform 15 has the outer diameter D1 of 20 mm, the inner diameter of 4.5 mm, and the thickness t1 of the clad pipe is 0.5 mm.

The preform 15 is subject to the drawing process 16 by use of the manufacture equipment 70 shown in FIGS. 6 to 8. The heating furnace 74 comprises five heater units 90-94 each of which has the inner diameter of 80 mm. The temperatures of the heater units 90-94 are 215° C., 164° C., 144° C., 111° C. and 60° C., in this order listed from the upstream side with respect to the drawing direction of the preform 15. The seal member 106 is made of a silicone rubber. The diameter D3 of the seal member 106 is 20 mm, which is the same as the diameter D1 of the preform 15. The contact area 107d is not provided in the seal member 106. The melt-drawing process is carried out such that the diameter D5 of the manufactured POF 17 is 316 μm. The fluctuation in the temperature of the heater units 90-93 in the upper side is 0.15° C., and the fluctuation in the temperature of the lowermost heater unit 94 is ±0.4° C. The fluctuation in the diameter of the drawn POF 17 under this condition is ±3 μm, so the good result is achieved.

(Experiment 2)

In this experiment, the conditions are the same as Experiment 1, except that the heating furnace 74 shown in FIGS. 9 and 10 is applied. The material of the seal member L10 is silicone rubber, and the diameter D4 is 2 mm. The fluctuation in the temperature of the heater units 90-94 is ±0.1° C. The fluctuation in the diameter of the drawn POF 17 under this condition is ±2 μm, so the good result is achieved.

(Experiment 3)

In this experiment, the seal members 106, 110 are attached to the upper and the lower sides of the heating furnace 74, as illustrated in FIG. 11. The material of the seal member 106 is polycarbonate, and the diameter D3 is 20 mm. The material of the seal member 110 is silicone rubber, and the diameter D6 is 2 mm. The fluctuation in the temperature of the heater units 90-94 is ±0.1° C. The fluctuation in the diameter of the drawn POF 17 under this condition is ±2 μm, so the good result is achieved.

(Experiment 4)

In this experiment, the spacer 121 is attached to the upper face of the heating furnace 74, and the seal member 122 is attached to the upper face of the spacer 121, as illustrated in FIG. 12. The spacer 121 is made of Hemisal as a heat insulator, and the height of the spacer 121 is 10 cm. The material of the seal member 122 is urethane rubber, and the diameter D3 is 19 mm. The fluctuation in the temperature of the heater units 90-93 in the upper side is ±0.15° C., and the fluctuation in the temperature of the lowermost heater unit 94 is ±0.4° C. The fluctuation in the diameter of the drawn POF 17 under this condition is ±3 μm, so the good result is achieved.

(Experiment 5)

In this experiment, the spacer 131 is attached to the upper face of the heating furnace 74, and the seal member 132 is attached to the upper face of the spacer 131, as illustrated in FIG. 13. The spacer 131 is made of Hemisal as a heat insulator, and the height of the spacer 131 is 5 cm. The material of the seal member 132 is silicone rubber, and the diameter D3 is 19.5 mm. The stainless cylindrical pipe 133 having the length of 20 cm and the diameter of 1 cm is connected to the lower face of the heating furnace 74. The seal 3 member 134 is provided in the other side of the cylindrical pipe 133. The material of the seal member 132 is polycarbonate, and the diameter D6 is 2 mm. The temperatures of the heater units 90-94 are 220° C., 170° C., 150° C., 116° C. and 64° C., in this order listed from the upstream side with respect to the drawing direction of the preform 15. The diameter D5 of the POF 17 is 750 μm. The fluctuation in the temperature of the heater units 90-94 is ±0.1° C. The fluctuation in the diameter of the drawn POF 17 under this condition is ±4 μm, so the good result is achieved.

The same experiment is performed by changing the diameter D6 of the seal member 134 into 3 mm, the same result as the seal member 134 with the diameter D6 of 2 mm is obtained.

(Experiment 6)

As for the comparison experiment, no seal member is attached to the heating furnace 74. By use of such heating furnace, the melt-drawing process of the preform 15 is carried out to obtain the POF 17. The fluctuation in the temperature of the heater units 90-94 is 0.7° C. to 1.5° C. The fluctuation in the diameter of the drawn POF 17 under this condition is ±15 μm, which becomes worse than the above experiments.

### Embodiment 2

In the above embodiment, the temperature in the heating furnace for melt-drawing process is controlled to reduce fluctuation in the diameter of the manufactured POF. In order to improve the quality of the POF, it is necessary to reduce the bubbles in the POF. Next, the manufacture method capable of reducing the bubbles in the POF is described. It is to be noted that, in Embodiment 2, the description about the structure of the POF (the core part and the clad part), the polymerization initiator, the chain transfer agent, the refractive index control agent, and the coating layer is the same as Embodiment 1, so the description about these elements are omitted. In addition, the first process to form the preform is the same as Embodiment 1, so the description about the first process is omitted.

(Second Process)

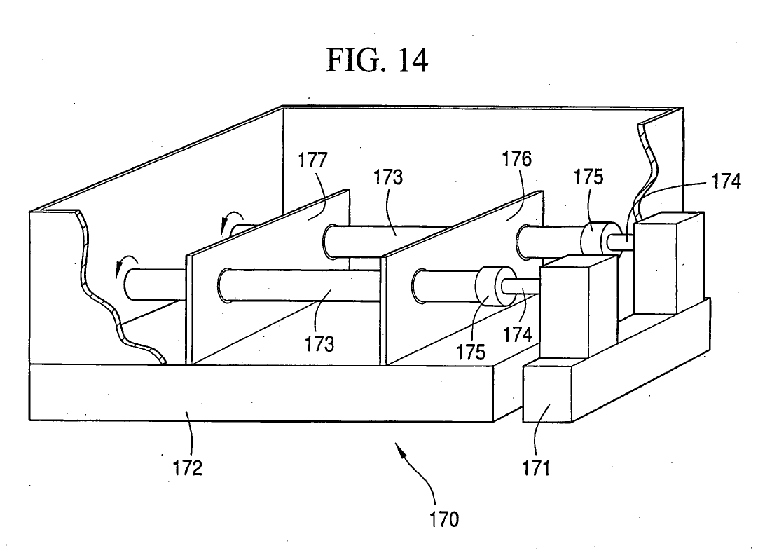

In Embodiment 2, the core part (or the inner core part) is formed by the rotational gel polymerization in which the hollow pipe as the clad pipe is rotated and the inner wall of the hollow pipe is swelled and melted by the monomer solution absorbed in the hollow pipe. Thereby, the monomer solution for the core part is polymerized. It is to be noted that the core part is formed in the following description. As shown in FIG. 14, a rotational polymerization apparatus 170 comprises a rotation drive section 171 and a polymerization section 172. The rotation drive section 171 has a motor (not illustrated) to rotate a polymerization chamber 173 provided in the polymerization section 172. The polymerization chamber 173 is connected to the rotation drive section 171 via a rotational shaft 174 and an adaptor 175. The rotation speed of the polymerization chamber 173 is controlled by the motor in the rotation drive section 171. The polymerization chamber 173 is held by a pair of support plates 176, 177 such that the longitudinal axis of the polymerization chamber is kept horizontally. A heating device (not illustrated) provided with the rotational polymerization apparatus 170 controls the reaction temperature in the rotational polymerization process.

If the hollow pipe (clad pipe) has excellent mechanical strength, the hollow pipe itself can be used as the polymerization chamber 173. If the hollow pipe does not have sufficient strength, or if the rotation speed of the hollow pipe in the polymerization is high, the hollow pipe is inserted in the polymerization chamber 173 before the rotational polymerization. As for the material of the polymerization chamber 173, a metal (such as stainless), a ceramics and a glass are preferably used.

The inner core solution is poured in the hollow part of the clad pipe (hollow pipe) having the outer core. The inner core solution contains the polymerizable monomer, additives such as the polymerization initiator, refractive index control agent (dopant), and so forth. After pouring the inner core solution, one end of the clad pipe is tightly sealed and the clad pipe as the polymerization chamber 173 is set horizontally (the longitudinal axis of the clad pipe is kept horizontally) in the rotational polymerization apparatus 170. The clad pipe is connected to the rotary shaft 174 via the adaptor 175. Then, the clad pipe containing the inner core solution is subject to polymerization at the rotation speed of 1500 rpm to 4000 rpm. The reaction temperature in the polymerization is 40° C. to 90° C. The rotational polymerization is carried out for 5 hours to 24 hours. A preliminary polymerization process before the rotational polymerization under the above condition is preferable in forming the inner core part having uniform thickness. As for the condition in the preliminary polymerization, it is possible to set the rotation speed of 0 rpm to 1500 rpm, the reaction temperature of 35° C. to 75° C., and the polymerization period of 0.5 hour to 3 hours. But the condition in the preliminary polymerization is not limited to those.

The inner core solution may be injected collectively, continuously or successively in the clad pipe. Instead of the GI type POF, a multi step type optical fiber having step-shape refractive index profile by adjusting the amount, composition and polymerization degree of the inner core polymerizable composition.

Compared with the interfacial gel polymerization, the rotational polymerization method can discharge the bubbles to be generated from the core solution because the core solution has larger surface area than the gel. Therefore, the bubbles in the produced preform decreases. In addition, forming the core part by the rotational polymerization method, the preform may have a void in the center. In such case, the void in the preform is filled by the melt drawing process to manufacture a plastic optical member such as the POF. Such preform can be utilized as other type of the optical member such as the plastic lens by closing the void in the preform in the melt drawing process.

The amount of the bubbles to be generated after the polymerization process can be decreased by cooling the preform at a constant cooling speed under the control of the pressure at the stage to complete the second process. In terms of the pressure response of the core part, the pressure polymerization of the core part in the atmosphere of nitrogen gas is preferable. But it is impossible to completely discharge the gas from the preform, and the cooling process will cause rapid shrinkage of the polymer so that the bubble are generated due to the bubble nucleus formed by gas accumulation to the void in the preform. In order to prevent such problem, it is preferable to control the cooling speed. The cooling speed is preferably 0.001° C./min to 3° C./min, more preferably 0.01° C./min to 1° C./min. The cooling process can be carried out by two steps or more in accordance with the progress of the volume shrinkage of the polymer in the core part in changing the temperature to the glass transition temperature Tg (° C.). In that case, it is preferable to set a high cooling speed just after polymerization and then gradually reduce the cooling speed.

The preform after the above described processes has uniform refractive index distribution and sufficient optical transparency. In addition, the amount of the bubbles and microscopic void is reduced. The flatness of the interface between the clad part (or the outer core part) and the core part becomes excellent. Although the above manufacture method describes the cylindrical preform with a single outer core layer, the outer core part having two or more layers may be formed. After the optical fiber is manufactured by the interfacial gel polymerization and the drawing processes, the outer core part may be integrated with the inner core part.

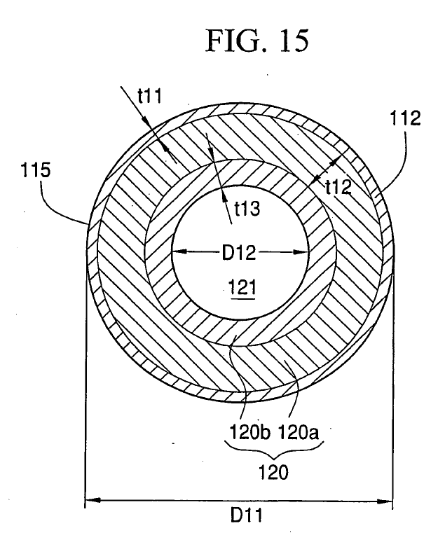

In FIG. 15, the cross section of the preform 115 is illustrated. For the purpose of obtaining excellent transmittance, the inner core 120b is preferably the graded index type (GI type) in which the refractive index decreases from the center to the surface. The outer core 120a is formed from a material capable of interfacial gel polymerization in forming the inner core 120b.

The shape of the preform 115 is not limited to that illustrated in FIG. 15. The outer diameter D11 (mm) of the clad pipe 112 is preferably 10 mm to 100 mm, and the thickness t11 of the clad pipe 112 is preferably 0.5 mm to 15 mm. The outer diameter D11 of less than 10 mm makes the productivity worse, and the outer diameter D11 of more than 100 mm will make it difficult to carry out the drawing process 16. It is preferable to form the inner core 120b with the thickness t13 (mm) of 2 mm to 15 mm after forming the outer core 120a having the thickness t12 (mm) of 2 mm to 10 mm. Thereby, a hollow part 121 is formed in the inner core 120b. The diameter (inner diameter of the preform 115) D12 (mm) of the hollow part 121 is preferably 1 mm to 20 mm. The diameter D12 (mm) is preferably equal to or more than 0.05×D11 (mm) and equal to or less than 0.4×D11 (mm). More preferably, the diameter D12 is equal to or more than 0.05×D11 (mm) and equal to or less than 0.35×D11 (mm), and most preferably the diameter D12 is equal to or more than 0.05×D11 (mm) and equal to or less than 0.3×D11 (mm). If the diameter D12 of the hollow part is more than 0.4×D11 (mm), the size of the hollow part 121 becomes large relative to the size of the preform 115. As a result, the manufactured POF 117 may be deformed or the hollow part is remained in the manufactured POF 117.

Various kinds of the plastic optical members can be manufactured by processing the preform. For instance, after the preform 115 is drawn at a drawing speed enough to close the hollow part of the preform 115, the preform 115 is sliced in the direction perpendicular to the longitudinal direction. Thereby, it is possible to manufacture disk-shaped or cylindrical shaped lenses with flat surfaces. The POF can be manufactured by melt-drawing the preform. When the core part of the preform has refractive index profile, the POF with uniform optical transmittance can be stably manufactured with high productivity.

(Third Process)

In the melt-drawing as the third process, the preform is heated by passing through a heating chamber (cylindrical heating chamber, for example), and drawing the molten preform. The heating temperature can be determined in accordance with the material of the preform. In general, the heating temperature is preferably 180° C. to 250° C. The drawing condition (such as the drawing temperature) can be determined in accordance with the materials and the diameter of the POF. In forming the GI type POF having the refractive index profile in the core part, it is necessary to carry out the drawing processes evenly in the radial direction of the POF, in order not to destroy the refractive index profile. Thus, the cylindrical heater capable of heating the preform uniformly over the section thereof is preferably used for the heating process. The heating chamber preferably has a distribution in the temperature in the drawing direction of the preform. In order to prevent to destroy the refractive index profile, the heating area in the preform is preferably as small as possible. In other words, it is preferable to carry out preheat process at the position before the heating area, and to carry out cooling process at the position after the heating area. The heating device for the heating process may be a laser device that can supply high energy in a small heating area.

The drawing apparatus for the drawing process preferably has a core position adjusting mechanism to keep the position of the core, in order to keep the circularity of the preform. It is possible to control the orientation of the polymer of the POF by adjusting the drawing condition, and thus possible to control the mechanical property (such as the bending quality), thermal shrinkage, and so forth.

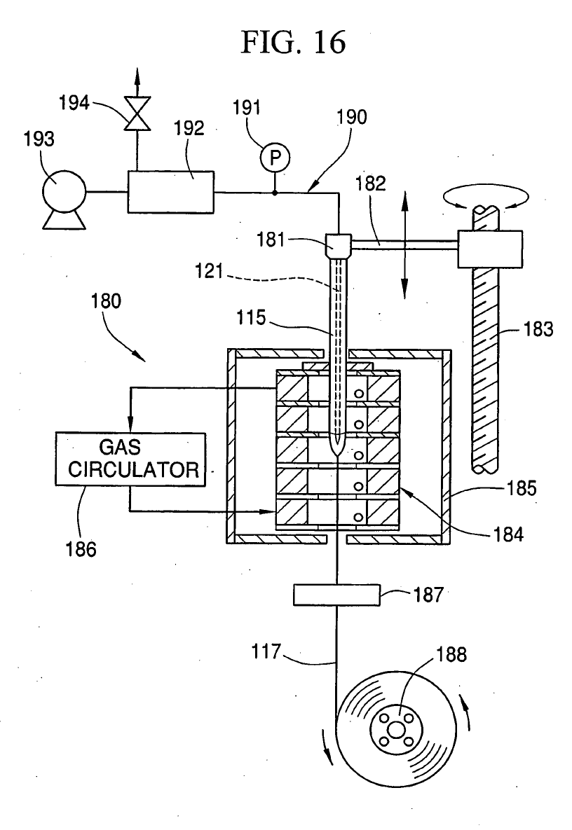

In FIG. 16, manufacture equipment 180 for manufacturing the POF 117 is illustrated. The preform 115 is supported by a vertical movement arm 182 (hereinafter referred to as “arm”) 182 via an adaptor 181. The arm 182 is vertically movable by the rotation of a vertical movement screw 183 (hereinafter referred to as “screw”). When the screw 183 is rotated to move the arm 182 downward slowly (for example, 1 mm/min to 20 mm/min), the lower end of the preform 115 enters a hollow cylindrical heating furnace 184 that is contained in a heater 185. The particulars of the heating furnace 184 will be described later. It is preferable to provide a gas supply device to make the heating furnace 184 in an inert gas atmosphere.

Examples of the inert gas to be supplied are nitrogen gas, helium gas, neon gas and argon gas, but the kind of the inert gas is not limited to those listed above. In terms of the manufacture cost, nitrogen gas is preferably used. In terms of thermal conductivity, helium gas is preferable. A mixture gas, such as a mixture gas of helium and argon, is preferable in obtaining the desirable thermal conductivity and reducing the manufacture cost. The inert gas may be circulated because the inert gas is supplied for the purpose of keeping the heating furnace in an inert gas atmosphere and controlling the thermal conductivity in the heating furnace 184. A gas circulator 186 may be connected to the heating furnace 184 for circulating inert gas to reduce the cost of inert gas. The preferable supply of inert gas depends on the heating condition and the kind of the gas to be supplied. As for helium gas, the supply is preferably 1 L/min to 10 L/min (in a room temperature).

The diameter of the POF 117 after the melt-drawing process is measured by use of a diameter measure device 187, and then the POF 117 is wound around a winding reel 188. The moving speed of the arm 182, the heating temperature of the heating furnace 184, the winding speed of the winding reel 188 and so forth, are controlled so as to obtain the POF 117 with a desirable diameter.

One end of the preform 115 is closely contacted or fitted to the adaptor 181 via a material having excellent adhesion. In order to vacuum (decompress) the hollow part of the preform 115, a decompression line 190 is connected to the adaptor 181. The decompression line 190 has a pressure gauge 191, a buffer tank 192, a vacuum apparatus 193 and a pressure control valve 194. As the vacuum apparatus 193, a vacuum pump and a decompression blower can be used. The adaptor 181 seals the connection between the decompression line 190 and the hollow part 121 of the preform 115 in an air-tight manner. The decompression degree is preferably equal to or higher than (−10 kPa to atmospheric pressure) and equal to or lower than (−0.4 kPa to atmospheric pressure). If the pressure in the hollow part 121 is lower than (−10 kPa to atmospheric pressure), the preform 115 tend to be deformed due to too much shrinkage of the inner wall of the preform 115. In addition, the outer diameter of the POF 117 becomes uneven because the position to shrink the hollow part 121 is fluctuated. If the pressure in the hollow part 121 is higher than (−0.4 kPa to atmospheric pressure), it is difficult or impossible to reduce the amount of the bubbles to be generated in the POF 117 during the melt-drawing process, and to close the hollow part in the preform 115 by the melt-drawing process.

The variation of the decompressed pressure to a set pressure P (Pa) is preferably 0.001×P (Pa) to 0.05×P (Pa). Instead, the variation of the decompressed pressure is preferably equal to or less than 0.5 kPa. Thereby, it is possible to keep the position to close the hollow part 121 of the preform 115 and to close the hollow part 121 completely. Thereby, the POF 17 with uniform diameter can be obtained.

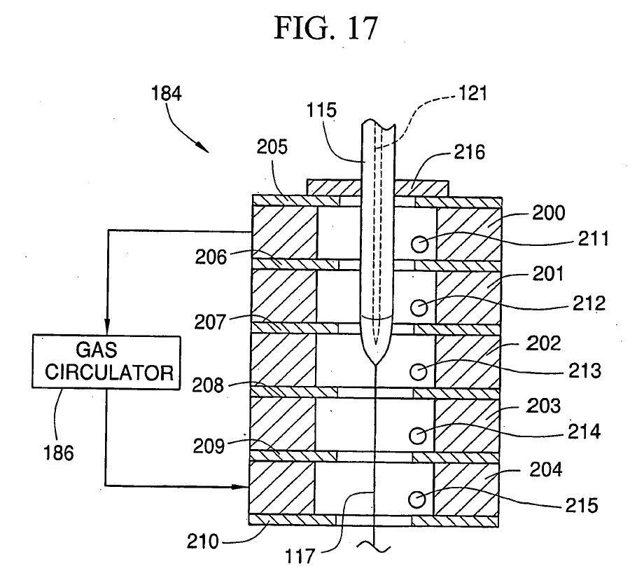

In FIG. 17, the heating furnace 184 is illustrated. The gas circulator 186 supplies inert gas to set the heating furnace 184 in the inert gas atmosphere. The heating furnace 184 comprises five heater units 200, 201, 202, 203 and 204 that are piled along the direction to draw the preform 115. The number of the heater units is not limited to five. The heating furnace 184 preferably has 2 heater units to 10 heater units, more preferably 3 units to 8 units. Although one gas circulator 186 is connected to the heating furnace 184, plural gas circulators may be provided for each of the heater units 200-204. The gas circulator 186 is independently provided with each of the heater units 200-204. One gas circulator may be provided for plural heater units.

An orifice 205 is provided on the top face of the uppermost heater unit 200. Orifices 206-209 are provided between the adjacent heater units. An orifice 210 is provided on the bottom face of the lowermost heater unit 104. These orifices 205-210 make it possible to create plural heating sections in which the temperature can be adjusted independently. The heating sections may be provided with thermometers 211-215, respectively. Based on the temperature in each section measured by the thermometers 211-215, the output power of the heater units 200-204 are controlled. The temperature fluctuation in each section heated by the heater unit 200-204 is preferably 0.5° C. or smaller. Thereby, it is possible to keep the position to close the hollow part of the preform 115, and to close the hollow part completely.

A seal member 216 is preferably attached to the top face of the orifice 205. The seal member 216 exhibits high sealing effect when the seal member 216 comes in contact with the preform 115, so the sealing member 216 needs to have heat-resistance and softness not to damage the preform 115. As the material of the seal member 216, a carbon felt and a rubber sheet such as a silicon rubber are preferable. A glass and a ceramics having excellent heat-resistance can be used as long as the preform 115 is not damaged. As for the drawing condition to draw the leading end of the molten preform 115 in which the hollow part is closed, a spinning condition to draw the preform without the hollow part can be applied. The drawing tension may be within the range described in JP-A Nos. 7-234322 and 7-234324. It is also preferable to control fluctuation in the outer diameter of the POF by use of a mechanism to adjust the outer diameter.

Normally, at least one protective layer is coated with the POF, for the purpose of improving flexural and weather resistance, preventing decrease in property by moisture absorption, improving tensile strength, providing resistance to stamping, providing resistance to flame, protecting damage by chemical agents, noise prevention from external light, increasing the value by coloring, and the like. The coating process can be carried out successively with the drawing process as the third process, as long as the properties of the plastic optical fiber are not affected. The particulars of the structure of the coating are the same as those described in Embodiment 1.

(Experiments)

The present invention will be described in detail with reference to Experiments (7)-(9) as the examples of the present invention and Experiments (10)-(11) as the comparisons. The materials, contents, operations and the like will be changed so far as the changes are within the spirit of the present invention. Thus, the scope of the present invention is not limited to the Experiments described below. The description below explains Experiment (7) in detail. Regarding Experiments (8)-(11), the portions different from Experiment (7) will be explained.

(Experiment 7)

The particulars of the preform 115 are the same as that explained in Experiment 1 according to Embodiment 1. The preform 115 is fixed to the adaptor 181 shown in FIG. 16. The heating furnace 184 comprises five heater units 200-204 each of which has the inner diameter of 80 mm. The temperatures of the heater units 200-204 are 215° C., 164° C., 144° C., 111° C. and 60° C., in this order listed from the upstream side with respect to the drawing direction of the preform 115. No seal member is attached to the top side of the heating furnace 184. The preform 115 is fed into the heating furnace 184 at the constant speed of about 2 mm/min. When the leading end of the preform 115 is melted and a thread-shaped molten preform is moved down, the decompression line 90 is operated to carry out the melt-drawing process at the condition that the pressure P in the hollow part 121 is (−1.0 kPa to the atmospheric pressure). The POF 117 having the length of 500 m and the outer diameter of 300 μm is obtained at the drawing speed of 10 m/min. The fluctuation in the decompressed pressure during the drawing process 16 is 0.02 kPa. The hollow part 121 is closed in the second heater unit 201. The fluctuation in the temperature of the heater units 200-203 in the upper side is ±0.2° C., and the fluctuation in the temperature of the lowermost heater unit 204 is ±0.4° C.

The obtained POF 117 is scanned over the whole length by use of a CCD camera, but the bubbles caused by the improper closing of the hollow part cannot be found. The transmission loss of the POF 117 at the wavelength of 650 nm (by use of a laser device) is 145 dB/km, so a good result is achieved.

(Experiment 8)

The preform 115 has the outer diameter D11 of 32 mm, the inner diameter D12 (the diameter of the hollow part) of 7 mm, and the thickness t11 of the clad pipe of 1 mm. As described in Experiment 7, the preform 115 is fixed to the adaptor 181. The temperatures of the heater units 200-204 are 245° C., 189° C., 144° C., 111° C. and 60° C., in this order listed from the upstream side with respect to the drawing direction of the preform 115. No seal member is attached to the top side of the heating furnace 184. The preform 115 is fed into the heating furnace 184 at the constant speed of about 1.2 mm/min. The melt-drawing process is carried out at the condition that the pressure P in the hollow part 121 is (−8 kPa to the atmospheric pressure). The POF 117 having the length of 300 m and the outer diameter of 750 μm is obtained. The fluctuation in the decompressed pressure during the drawing process 16 is 0.1 kPa. The hollow part 121 is closed in the second heater unit 201. The fluctuation in the temperature of the heater units 200-203 in the upper side is ±0.2° C., and the fluctuation in the temperature of the lowermost heater unit 204 is ±0.3° C.

The obtained POF 117 is scanned by use of a CCD camera, but the bubbles caused by the improper closing of the hollow part cannot be found. The transmission loss of the POF 117 is 140 dB/km, so a good result is achieved.

(Experiment 9)

The preform 115 has the outer diameter D11 of 50 mm, the inner diameter D12 (the diameter of the hollow part) of 6 mm, and the thickness t11 of the clad pipe of 1 mm. The temperatures of the heater units 200-204 are 270° C., 223 DC, 173 DC, 131° C. and 83° C., in this order listed from the upstream side with respect to the drawing direction of the preform 115. The seal member 216, made of silicon rubber, is attached to the top side of the heating furnace 184. The preform 115 is fed into the heating furnace 184 at the constant speed of about 1.0 mm/min. The melt-drawing process is carried out at the condition that the pressure P in the hollow part 121 is (−5 kPa to the atmospheric pressure). The POF 117 having the length of 250 m and the outer diameter of 1.0 mm is obtained. The fluctuation in the decompressed pressure during the drawing process 16 is 0.05 kPa. The hollow part 121 is closed in the third heater unit 202. The fluctuation in the temperature of the heater units 200-203 in the upper side is to ±0.1° C., and the fluctuation in the temperature of the lowermost heater unit 204 is ±0.3° C.

The obtained POF 117 is scanned by use of a CCD camera, but the bubbles caused by the improper closing of the hollow part cannot be found. The transmission loss of the POF 117 is 147 dB/km, so a good result is achieved.

(Experiment 10)

In Experiment 10 as the comparison experiment, the POF having the length of 500 m is obtained under the same condition as Experiment 7, except that the decompressed pressure in the hollow part is (−15 kPa to the atmospheric pressure). The fluctuation in the decompressed pressure during the drawing process 16 is 0.8 kPa. The hollow part 121 is closed in the second heater unit 201. The fluctuation in the temperature of the heater units 200-203 in the upper side is ±0.2° C., and the fluctuation in the temperature of the lowermost heater unit 204 is ±0.4° C. In the obtained POF, there are five bubbles caused by improper closing op the hollow part. The transmission loss of the POF 117 is 185 dB/km, which is higher than Experiments (7)-(9).

(Experiment 11)

In Experiment 11 as the comparison example, the preform 115 has the outer diameter D11 of 20 mm, the inner diameter D12 of 7 mm and the clad pipe thickness t11 of 0.5 mm. The decompression line 190 is detached from the heating furnace 184, so the hollow part 121 is not subject to decompression. Plural bubbles caused by the improper closing of the hollow part are found. The transmission loss of the POF 117 is 250 dB/km.

### INDUSTRIAL APPLICABILITY

The present invention is applicable to an optical member such as a plastic optical fiber, an optical connector, lenses, optical films, and so forth. In addition, the present invention is applicable to manufacture a structure by melt-drawing a pipe-shaped base material.

1. An apparatus for manufacturing a plastic optical fiber by inserting a plastic optical fiber base material in a heating furnace through a top opening formed in the top side of the heating furnace, and by melt-drawing the plastic optical fiber base material in the heating furnace to draw the plastic optical fiber through a bottom opening formed in the bottom side of the heating furnace, the apparatus comprising:
at least three heater units arranged along the direction to draw the plastic optical fiber, the heater units being capable of controlling the temperature in the heating furnace independently;
plural dividing members for dividing the heating furnace into plural sections in each of which the heater unit is provided; and
a seal member, provided at least one of the top side and the bottom side of the heating furnace, for shielding the heating furnace from external air.

2. The manufacture apparatus according to claim 1, wherein the seal member is attached to the top side of the heating furnace and the diameter D3 (mm) of an opening formed in the seal member for passing the plastic optical fiber base material satisfies the following condition;
1.2×D1<D3≦1.5×D1
wherein D1 (mm) is the outer diameter of the plastic optical fiber base material.

3. The manufacture apparatus according to claim 1, wherein the seal member is attached to the top side of the heating furnace and the diameter D3 (mm) of an opening formed in the seal member for passing the plastic optical fiber base material satisfies the following condition;
0.75×D1≦D3≦D1
wherein D1 (mm) is the outer diameter of the plastic optical fiber base material.

4. The manufacture apparatus according to claim 1, wherein the seal member is attached to the bottom side of the heating furnace and the diameter D6 (mm) of an opening formed in the seal member for passing the plastic optical fiber satisfies the following condition;
1.2×D5≦D6≦10×D5
wherein D5 (mm) is the outer diameter of the plastic optical fiber.

5. The manufacture apparatus according to claim 1, further comprising a hollow spacer with heat-resistance that is provided between the top side of the heating furnace and the seal member.

6. The manufacture apparatus according to claim 1, further comprising a gas supply device for supplying gas including at least one of helium, argon and nitrogen.

7. A method for manufacturing a plastic optical fiber, the method comprising the steps of:
(a) independently controlling the temperature in each of divided sections in a heating furnace for melt-drawing a plastic optical fiber base material such that the temperature variation in each section is ±0.5° C. to a predetermined temperature, a seal member for shielding the heating furnace from external air being provided in at least one of the top side and the bottom side of the heating furnace;
(b) inserting the plastic optical fiber base material in a opening formed in the top side of the heating furnace; and
(c) melt-drawing the plastic optical fiber base material in the heating furnace to draw the plastic optical fiber through an opening formed in the bottom side of the heating furnace.

8. A method for manufacturing a plastic optical fiber, the method comprising the steps of:
(a) melt-drawing a hollow cylindrical plastic optical fiber base material in a heating furnace, the optical fiber base material having a core part in which a hollow part is formed and a clad part around the core part; and
(b) decompressing the hollow part of the core part at a pressure from (−10 kPa to atmospheric pressure) to (−0.4 kPa to atmospheric pressure) during the melt-drawing of the plastic optical fiber base material.

9. The manufacture method according to claim 8, wherein the heating furnace is divided into plural sections along the direction to draw the plastic optical fiber, the temperature in each sections being independently controlled, the method further comprising the step of:
(c) controlling the temperature in the sections from the section to insert the plastic optical fiber base material to the section in which the hollow part in the core part disappears, such that the temperature variation becomes within 0.5° C. to the set temperature in each section.

10. The manufacture method according to claim 8, wherein the variation in the decompressed pressure is 0.001×P to 0.05×P, in which P indicates a set value of the decompressed pressure.

11. The manufacture method according to claim 8, wherein the variation in the decompressed pressure in the hollow part is equal to or less than 0.5 kPa.

12. The manufacture method according to claim 8, wherein the diameter D11 of the plastic optical fiber base material is 10 mm to 100 mm.

13. The manufacture method according to claim 8, wherein the diameter D12 (mm) of the hollow part of the plastic optical fiber base material satisfies the following condition;
0.05×D11≦D12≦0.04×D11
wherein D11 (mm) is the outer diameter of the plastic optical fiber-base material.

14. The manufacture method according to claim 8, wherein the main component of the core part is a polymer of a bulk polymerizable monomer.

15. The manufacture method according to claim 14, wherein the polymer is acrylic resin.

16. The manufacture method according to claim 8, further comprising the steps of:
(d) pouring a reactive solution including a polymerizable monomer and a refractive index control agent in a hollow cylindrical pipe having at least the clad part;
(e) keeping the hollow cylindrical pipe substantially horizontally; and
(f) polymerizing the reactive solution to form the plastic optical fiber base material while the hollow cylindrical pipe is rotated, thereby the core part has a refractive index profile in which the refractive index decreases from the interface with the hollow part to the interface with the clad part.

17. The manufacture method according to claim 16, wherein the polymerizable monomer is methyl methacrylate.
